(19) United States
(12) Patent Application Publication
(10) Pub. No.: US 2012/0074058 A1
(43) Pub. Date: Mar. 29, 2012

(54) NUTRIENT RECOVERY METHODS AND USES THEREOF

(75) Inventors: Le Zeng, Edmonton (CA); Xiaomei Li, Edmonton (CA)

(73) Assignee: HIGHMARK RENEWABLES RESEARCH, L.P., Vegreville, AB (unknown)

(21) Appl. No.: 13/246,352

(22) Filed: Sep. 27, 2011

Related U.S. Application Data
(63) Continuation of application No. 61/387,575, filed on Sep. 29, 2010.

(51) Int. Cl. C02F 9/00

(52) U.S. Cl. 210/631

(57) ABSTRACT

Provided herein is an efficient solid-liquid separation method for bio-waste material treatment. The method contemplates the addition of certain cationic polyelectrolytes (or “polymers” as used herein) to the bio-waste materials prior to solid-liquid separation, such as centrifugation, thus greatly facilitate the subsequent solid-liquid separation step. The liquid portion, once separated from solid portion using the subject methods, can be subjected to further downstream nutrient recovery manipulations (such as phosphate precipitation and ammonia stripping) with potentially better efficiency, or may be used directly in a number of operations, such as a liquid diluent for feedstocks in an ethanol plant.

### BACKGROUND OF THE INVENTION

With the rapid expansion of intensive livestock operation worldwide, and with the increasing demand of renewable energy production from biomass, large-scale anaerobic digestion of what were formerly considered “bio-waste materials” (such as animal manure) for biogas production has gained much attention, due to the potential economic and environmental benefits. Anaerobic digestion produces methane rich biogas, as well as a digested effluent (also known as anaerobic digestate) containing significant amounts of various nutrients, including nitrogen, phosphorus, and other plant nutrients. These nutrients are valuable for plant growth, however, nutrient concentration in the digestate may be relatively low compared to commercial fertilizers. Currently, the only practically feasible option for managing digestate is direct application to land. Due to the low concentration of nutrients, the relative cost of transportation can be high, limiting economic value of digestate. Stockpiling of digestate may occur as a result, meaning that nutrients contained therein may pose potential environmental risk to the surrounding water bodies if improperly managed. More effective separation of liquids from solids in digestate would allow for increased saleability of these products and their derivatives, and thus a much lowered environmental risk.

### SUMMARY OF THE INVENTION

The invention described herein provides an improved method and systems for more effectively separating liquids from solids in bio-waste materials, such as anaerobic digestate, which may be useful for better extraction of the various nutrients in the bio-waste materials.

Thus one aspect of the invention provides a solid-liquid separation method for a bio-waste mixture, comprising: (1) adding a high molecular weight cationic polyelectrolyte to the bio-waste mixture; and, (2) separating a solid portion from a liquid portion of the bio-waste mixture through mechanical/physical means.

In certain embodiments, the bio-waste mixture is wastewater, sewage, etc. In certain embodiments, the bio-waste is an anaerobic digestate resulting from anaerobic digestion of an organic waste. The organic waste may comprise one or more of: livestock manure, animal carcasses and offal, plant material, wastewater, sewage, food processing waste, human-derived waste, discarded food, or a mixture thereof.

In certain embodiments, the bio-waste mixture has a solid content of about 2-15%, about 3-10%, or about 5-8%.

In certain embodiments, the high molecular weight cationic polyelectrolyte is a CIBA® ZETAG®-type cationic polyelectrolyte or similar synthetic or natural chemical compounds.

In certain embodiments, the CIBA® ZETAG®-type cationic polyelectrolyte is one or more of: CIBA® ZETAG® 7623 (or 8110), 7645, 7587, and 5250, and MAGNAFLOC® 338, 351, 1011, preferably CIBA® ZETAG® 7623 (or 8110) or 7645, or equivalent thereof.

In certain embodiments, the cationic polyelectrolyte is added to the bio-waste mixture at a final concentration of about 100-1000 mg/L, about 150-400 mg/L, or about 200-300 mg/L, or about 250 mg/L.

In certain embodiments, prior to adding the cationic polyelectrolyte to the bio-waste mixture, the bio-waste mixture is mechanically mixed.

In certain embodiments, the mechanical/physical means for solid-liquid separation includes centrifugation or a sludge dewatering apparatus (e.g., screw press or separator).

In certain embodiments, the method further comprises: (3) adding to the liquid portion a phosphate precipitation agents, and, (4) settling the resulting phosphate precipitation to produce a second liquid portion.

In certain embodiments, the phosphate precipitation agent is lime, woodash, or a Mg salt.

In certain embodiments, the method further comprises capturing ammonium from the second liquid portion and purifying the second liquid portion. The ammonium capture agents can be, for example, digested solids, digested solid treated by acids (such as H₂SO₄), etc.

In certain embodiments, the second liquid portion is purified through one or more steps of microfiltration, ultrafiltration, reverse osmosis, and/or ion exchange.

In certain embodiments, the purifying step is carried out prior to the ammonia capturing step.

In a related aspect, the invention provides systems or apparatus that are adapted to carry out the method steps of the invention. For example, the system of the invention may be a solid-liquid separation system having a dedicated port for adding the high molecular weight cationic polyelectrolyte to the bio-waste mixture, and any suitable mechanical/physical means for separating the solid portion from the liquid portion of the bio-waste mixture.

Any embodiments of the invention described herein are contemplated to be combinable with any other embodiments of the invention where applicable, even when the embodiments to be combined may be separately described under different aspects of the invention.

### BRIEF DESCRIPTION OF THE DRAWINGS

FIG. 1A schematic representation of a typical nutrient recovery flow chart. Some steps may be optional, and some steps may be performed in different sequences compared to what is shown.

FIG. 2 A schematic drawing showing an exemplary ammonia stripping process. 1—direct heat exchanger, 2—indirect heat exchanger, 3—ammonia stripping tower, 4—gas-liquid contactor (optional), 101—hot CO₂ or flue gas, 102 & 301—CO₂ stripping gas, 103—circulating water, 104 & 203—hot water, 201—lime-treated manure effluent after settling, 202 & 303—hot manure effluent, 204—cooled circulating water, 302—stripped gas, 304 & 403—NH₃ stripped effluent, 401—CO₂ gas, 402—CO₂ reduced gas, 404—effluent discharge.

FIG. 3 Representative results of ammonia stripping under different conditions. (3A) effect of temperature on ammonia stripping at pH 9.5 and 14% CO₂; (3B) effect of pH on ammonia stripping at 25° C. and 14% CO₂; (3C) effect of CO₂ concentration on ammonia stripping at 25° C. and pH 9.5; (3D & 3E) comparison of ammonia stripping from manure effluent at 25° C. and pH 10.9 and at 40° C. and pH 9.5-(3D) with 14% CO₂ gas, (3E) with 75% CO₂ gas; (3F & 3G) comparison of ammonia stripping from manure effluent with different concentrations of CO₂— (3F) at 25° C. and pH 10.9, (3G) at 40° C. and pH 9.5; (3H) ammonia stripping without maintaining pH-(A) NH₄Cl solution with 0% CO₂, (B) NH₄Cl solution with 14% CO₂, (C) manure solution with 14% CO₂; (3I) influence of the CO₂ concentration in stripping gas on alkaline consumption. Ammonium concentration was 2580 mg/L in synthetic solution and 2386 mg/L in digested manure effluent.

FIG. 4 Solution pH change with bubbling CO₂. (A) Centrifuged digested manure effluent (initial pH 12). (B) Centrifuged digested manure effluent (initial pH 10.5). (C) Centrifuged digested manure effluent (initial pH 7.6). (D) Lime-treated, NH₃-stripped digested manure effluent (initial pH 10.15). (E) Tap water (initial pH 11.5). (F) Tap water (initial pH 7.2).

FIG. 5 pH change with the amount of CO₂ injection for lime-treated and NH₃-stripped manure effluent at a rate of 0.2 L CO₂/(min·L effluent).

### DETAILED DESCRIPTION OF THE INVENTION

The invention is partly based on the surprising discovery that certain cationic polyelectrolytes (or “polymers” as used herein), when added to bio-waste materials prior to solid-liquid separation, greatly facilitate the subsequent solid-liquid separation step. The liquid portion, once separated from solid portion using the subject methods can be subjected to further downstream nutrient recovery manipulations with potentially greater efficiency, or may be used directly in a number of operations, such as a liquid diluent for feedstocks in an ethanol plant.

According to the instant invention, a solid-liquid separation method for a bio-waste mixture is provide, the method comprising: adding a high molecular weight cationic polyelectrolyte to the bio-waste mixture; and, separating a solid portion from a liquid portion of the bio-waste mixture through mechanical/physical means.

The high molecular weight cationic polyelectrolyte is preferably of the type and equivalent to the CIBA® ZETAG®-type cationic polyelectrolytes. Preferred CIBA® ZETAG®-type cationic polyelectrolyte include one or more of: CIBA® ZETAG® 7623 (or 8110), 7645, 7587, and 5250, and MAGNAFLOC® 338, 351, and 1011, most preferably CIBA® ZETAG® 7623 or 7645, or equivalent thereof. ZETAG® 8110 is very similar to ZETAG® 7623. It is also a cationic powder, with slightly higher charge and the same molecular weight and viscosity as ZETAG® 7623, and can be considered an equivalent/replacement thereof. These CIBA® ZETAG® or MAGNAFLOC® cationic polyelectrolytes are commercially available from CIBA Corp. (now owned by BASF Corp., Florham Park, N.J.).

A “CIBA® ZETAG®-type cationic polyelectrolyte” include all cationic polyelectrolytes having similar or identical physical/chemical properties, and/or function similarly or nearly identically as the respective CIBA® ZETAG® or MAGNAFLOC® products, including similar or nearly identical chemical composition, charge, average molecular weight, viscosity, and/or de-watering capacity, etc.

Suitable cationic polyelectrolyte may be added to the bio-waste mixture at various final concentrations, depending on the specific type of polymer used and the bio-waste material being treated. Exemplary concentrations for anaerobic digestate/manure effluent are about 100-1000 mg/L, about 150-400 mg/L, or about 200-300 mg/L, or about 250 mg/L polymers.

In certain embodiments, prior to adding the cationic polyelectrolyte to the bio-waste mixture (such as anaerobic digestate), the bio-waste mixture is mechanically mixed. This is partly based on the discovery that certain bio-waste mixture (such as anaerobic digestate) may contain a large amount of phosphate that can be precipitated with simple mechanical mixing without the addition of external phosphate-precipitation agents. Overall phosphate recovery/removal may be improved because of this mixing.

Most (if not all) bio-waste materials may be treated using the subject methods. In certain embodiments, the bio-waste mixture may be wastewater, sewage water, etc. In certain embodiments, the bio-waste is an anaerobic digestate resulting from anaerobic digestion of an organic waste. The organic waste may comprises one or more of: livestock manure, animal carcasses and offal, plant material, wastewater, sewage, food processing waste, human-derived waste, discarded food, or a mixture thereof.

Preferably, the bio-waste mixture has a solid content of about 2-15%, about 3-10%, or about 5-8%. For bio-waste material having higher solid content, dilution (with lower solid content wastewater of the same or different nature) may be used to adjust the total solid content.

Any suitable mechanical/physical means for solid-liquid separation or dewatering devices may be used to effect solid-liquid separation. Suitable means include screw press, rotary press, filter press, belt filter press, various kinds of centrifuges (including solid-bowl decanter), electrodewatering, etc.

In certain embodiments, the method further comprises: (3) adding to the liquid portion a phosphate precipitation agent, and, (4) settling the resulting phosphate precipitation to produce a second liquid portion. For example, the phosphate precipitation agent may be lime-based, may be a Mg salt, or may be wood ash-like materials. Lime-based phosphate precipitation agents may include quicklime or almost pure calcium oxide (e.g., above 95% CaO), hydrated lime (e.g., above 97% Ca(OH)₂) powder or lime milk thereof. Certain low-grade lime materials, such as limekiln dust (or lime milk thereof) can also be used. Limekiln dust is a complex mixture containing mostly CaCO₃, CaO, Ca(OH)₂, and CaMg(CO₃)₂. Suitable Mg salt may include, for example, MgCl₂, MgO, Mg(OH)₂, and MgSO₄, although relatively low efficiency MgCO₃ may also be used under certain conditions.

In certain embodiments, the method further comprises capturing ammonium from the second liquid portion and purifying the second liquid portion.

Ammonia removal from wastewater can generally be achieved through physico-chemical, biological means, or a combination of chemical and biological means, including air stripping, biological denitrification, steam stripping, selective ion exchange, membrane separation, and breakpoint chlorination, etc. The choice of a particular ammonia removal route may depend on the nature of the wastewater to be treated. The stripped NH₃ gas may be collected and purified in its gas form. Alternatively, NH₃ in the NH₃-enriched air may be further absorbed into a solid matrix.

In certain embodiments, the second liquid portion is purified through one or more steps of microfiltration, ultrafiltration, reverse osmosis, and/or ion exchange.

In certain embodiments, the purifying step is carried out prior to the ammonium-capturing step to increase the concentration of ammonia in the liquid portion to facilitate easier, more complete stripping.

In certain embodiments, if lime treatment is used, it is preferably carried out before ammonia stripping because lime precipitation increases solution pH, which may be beneficial to the ammonia stripping process.

Further details of the various aspects of the invention are described below.

### Phosphate Removal

Bio-waste water (e.g., anaerobic digestate) containing significant levels of element phosphorus may be treated by a number of phosphate-precipitation agents to remove/recover phosphate. In certain embodiments, element phosphate may be removed/recovered by simple physical means, such as repeated aqueous extraction (e.g., mix with water) and centrifugation.

Phosphorus removal from digested liquid can be achieved through physico-chemical, biological or combination of chemical and biological removal. The physico-chemical treatment processes may include precipitation, crystallization, and adsorption. For example, a struvite crystallization using MgO may be used for this purpose. Alternatively, lime precipitation processes may also be used for P recovery from the liquid.

The centrifuged digested liquid can react with wood ash and lime. As a result, phosphate precipitate along with residual solid particles may be separated from the liquids by settlement and/or additional rounds of centrifugation. The liquid effluent can then be pumped into the ammonia-stripping tower for ammonia stripping, or be subjected to water purification before or after ammonia stripping. In an exemplary set up, critical parameters for recovering 95% of the inorganic P included: pH ˜9-11.5, 2% of wood ash, and 0.8-1.5% of lime.

A. Struvite Precipitation

One typical phosphate-precipitation agent is magnesium-based agent for struvite precipitation. The struvite precipitation process can be used in wastewater treatment as well as other bio-waste treatments. The struvite precipitation reactions can be expressed as:

Mg²⁺+NH₄⁺+HPO₄²⁻+6H₂O→MgNH₄PO₄.6H₂O↓+H⁺

Mg²⁺+K⁺+HPO₄²⁻+6H₂O→MgKPO₄.6H₂O↓+H⁺

In this process, an equal number of moles of phosphate and ammonia (or potassium) is recovered. Meanwhile, an equal mole of magnesium is consumed as well.

Technically, a number of Mg salts can be used for the struvite precipitation process. Powders of the selected Mg salts can be directly added into the precipitation reactor. The choices may include MgCl₂, MgO, Mg(OH)₂, and MgSO₄. Although MgCO₃ is also a potential choice, it is not preferred especially for manure-related bio-waste, partly due to its relative low efficiency. On the other hand, MgCl₂ is preferred in certain embodiments because it dissolves faster in aqueous solution than many other Mg salts. In certain other embodiments, MgO or Mg(OH)₂ are preferred for struvite precipitation due to their lower costs and the added benefit of raising solution pH, which may be beneficial to downstream ammonia stripping.

In a representative flow-through system for struvite production suitable for manure effluents, two stirred reactors in series supply manure effluent and a Mg salt (e.g., MgO or Mg(OH)₂) suspension solution, respectively, to a first reactor and optionally a second reactor for struvite formation. The effluent is then settled inside a struvite settling tank (which may have a cylinder shape and a cone-shaped bottom) overnight. The supernatant from this tank is optionally mixed with certain amounts of wood ash and settled in a solids settling tank. After settling from several hours to overnight, the supernatant from this tank is directed through a granular activated carbon (GAC) column. Effluent from the GAC column can be stored in a storage tank for further treatment, such as ammonia removal and/or water purification. In a bench-scale trial, residual phosphate concentration below 12 mg PO₄³⁻/L was achieved using a similar set up. With increase of the initial available phosphate and Mg, phosphate removal efficiency may be further increased.

In embodiments where ammonia content in the bio-waste is much higher than the phosphate content, struvite precipitation may be used with the addition of phosphate such that a significant amount of total ammonia is also recovered with the phosphate in the bio-waste.

In certain embodiments, the pH of the struvite precipitation reaction is controlled to be 8 or above, preferably between 8.5-9.5, for optimal phosphate removal/recovery.

In certain embodiments, where the bio-waste is anaerobic digestate or manure effluents, the molar ratio of Mg/PO₄³⁻ in the reaction is preferably 2:1, 3; 1, 4:1 or higher.

In certain embodiments, the temperature of struvite precipitation is maintained at an ambient (room) temperature (e.g., about 20° C.).

In certain embodiments, the residence time for struvite precipitation is about 45-60 min.

In certain embodiments, struvite precipitation is carried out with the addition of certain materials as seeding, such as struvite powders, sand, fly ash, and bentonite powders. Adding sand or bentonite powders has the added benefit of improving phosphate removal efficiency, while adding struvite powder tends to increase the crystal size of the precipitated struvite.

In certain embodiments, struvite precipitation is used for digested manure for its better efficiency over the undigested manure.

In a large-scale stirred reactor of struvite precipitation, the stifling is preferably strong enough to mix solutions completely and at a high rate.

B. Lime Precipitation

Another typical inorganic phosphate-precipitation agent is lime-based with significant dissolved Calcium, such as the most commonly used calcium salt in a form of quicklime or almost pure calcium oxide (e.g., above 95% CaO), hydrated lime (e.g., above 97% Ca(OH)₂) powder or lime milk thereof. Others include low-grade lime materials, such as limekiln dust (or lime milk thereof) and granulime. Limekiln dust is a complex mixture containing mostly CaCO₃, CaO, Ca(OH)₂, and CaMg(CO₃)₂. In contrast, granulime contains mostly CaCO_{3 (>}90%), and may not be very effective due to its low dissolved calcium. For example, the pH of the limekiln dust solution is 12.44-12.49 at a dosage of 5-50 g/L in water, whereas the pH of the granulime solution is only 9.43-8.78 with the same dosage. For hydrated lime at a dosage of 10 g/L, the pH reached 12.46.

The lime precipitation reaction forms hydroxyapatite (Ca₁₀(PO₄)₆(OH)₂) described as:

Ca²⁺+6PO₄²⁻+8OH⁻→Ca₁₀(PO₄)₆(OH)₂↓+6H₂O

The dissolved Ca content changes with the lime dosage. The dissolved Ca in the aqueous solution of limekiln dust is about 940-1240 mg/L at a dosage of 5-50 g/L, whereas it is only about 24-150 mg/L with the same dosage for granulime. The dissolved Ca for hydrated lime at a dosage of 10 g/L reaches 945 mg/L. Thus, the dissolved Ca concentration appears comparable for hydrated lime and limekiln dust. This is likely owing to a limited solubility of Ca(OH)₂ in water. The available Ca(OH)₂ in limekiln dust, however, is much lower than that in hydrated lime. Unlike limekiln dust, the usable Ca in granulime is much smaller.

In certain embodiments, the hydrated lime dosages are about 10-12 g/L bio-waste (e.g., anaerobic digestate effluent). Although a lime dosage of 10 g/L is usually high enough for phosphate precipitation, a lime dosage of 15 g/L or higher may be required for better settling of the precipitate. Thus, in certain embodiments, a higher dosage (such as 15 g/L or above) may be used to facilitate better settling. In this regard, the settling curves for the lime dosages of 18 and 20 g/L nearly overlap, suggesting that further increase of lime dosage over 18 g/L would not significantly benefit manure slurry settling.

It appears that lime-treated manure slurry would not settle significantly in a short period of time (e.g., 1 day). Thus, in certain embodiments, a minimum of 2-3 days are required for settling. But with an enhanced settling system, this period may be reduced. After settling, pH is usually not considerably affected, while residual phosphate concentration is significantly reduced.

In certain embodiments, after lime treatment and proper settling for about 10 h in a settling tank, about 50-90%, or about 70% of the upper solution in the settling tank may be pumped out for further treatment (such as ammonia stripping) and the remaining bottom slurry may be centrifuged to remove solids.

In certain embodiments, the pH of lime precipitation is controlled to be within 8.0-11.0. pH is usually a critical factor that affects phosphate precipitation, and it may be affected by reaction temperature. For example, the pH of a reaction solution at 2.5° C. was 9.87 (the actual pH might be further below this value if the meter was calibrated at the lower temperature), which is lower than that at 25 and 48° C. (10.30-10.36). This lower pH at a lower temperature (2.5° C.) was most likely caused by the lower solubility of Ca(OH)₂ at the lower temperature, and hence a lower availability of dissolved calcium ions for precipitation reaction. Accordingly, the reaction temperature in the precipitation reactor for lime-based phosphate precipitation is preferably controlled at or above 20° C., e.g., about 20-30° C. Higher reaction temperature is usually not necessary.

The lime milk may be produced by mixing 200 g of hydrated lime powders with 600 ml of hot water (˜60° C.) under mechanical stifling. The milk mixture was continuously stirred at 55-65° C. for 30 min before use. The lime content in the lime milk was 27.4-28.3% by weight for different batches.

Phosphate precipitation using lime treatment can be effected according to standard procedure. For example, in a pilot reactor scale precipitation, Plexiglass reactor having an internal diameter (ID) of about 13.8 cm and a height of about 45 cm is equipped with a mechanical stirrer and a sampling valve located 15 cm from the bottom. About 5 L of the centrifuged digested manure effluent may be added to the reactor, and a certain amount of lime powders or lime milk can be added while the reaction solution is stirred at about 2000 rpm. When using lime combined with wood ash, wood ash may be added first, and then lime (powders or milk) may be added after 5 minutes of stifling. The reactor can be continuously stirred for about 40 minutes at room temperature (about 20° C.). A pH probe and a thermocouple may be set in the reactor for monitoring pH and temperature during the reaction. The reactor can be kept open during the reaction. After the reaction is substantially complete, the whole solution may be poured into a 6-L plastic pail for settling overnight. The clarified solution may be slowly poured out and the settled solids can be collected and dried at 80-90° C. for 16-24 hr. The samples of solution may be taken separately after the reaction and settling, and may be centrifuged immediately at about 3400 rpm for 15 min with a Cole-Parmer centrifuge. The supernatant of each centrifuged sample may be diluted by 50-500 times for phosphate analysis by Technicon. Ammonia nitrogen in the samples may be determined by the ammonia-selective electrode method with 10-fold dilution. For example, one diluted solution for each sample can be prepared and duplicate measurements can be carried out. The analytical error can generally be controlled to be within 3-5%.

Residual phosphate concentrations drop dramatically after the first 10 minutes of reaction, and then further reduces in another 10-20 min depending on the lime dosage. At the lime dosage of 12 g/L, for example, there is no virtual reduction in the residual phosphate concentration beyond 20 minutes of reaction; while at the lime dosage of about 10 g/L, the residual phosphate remains almost unchangeable after 30 minutes of reaction. Therefore, in certain embodiments, the required reaction time is at least 20-30 min at the lime dosage of about 10-12 g/L (about 20° C.). The required reaction time may be somehow shorter with an increase of lime dosage. For large size stirred precipitation reactor for phosphate removal from manure effluent by lime, the residence time in the reactor can be about 40-60 min.

In certain embodiments, wood ash may be used to facilitate or augment lime treatment. Wood ash has high content of alkali metal oxides, such as Na₂O, K₂O, and CaO. Addition of wood ash can increase the pH value of the bio-waste to be treated, and may help to reduce the lime dosage required for the precipitation. Furthermore, wood ash shows some effectiveness to reduce turbidity and color of manure effluents.

Wood ash treatment may be carried out in batch at room temperature (about 20° C.) and under atmospheric pressure. In a 250-ml Erlenmeyer flask, 100 ml of digested manure effluent (centrifuged) may be first added, and a fixed amount of lime milk (1 to 5 ml) is added using a pipettor (Eppendorf 2100 series, 500-5000 μl). The required wood ash is weighed accurately and added into the flask. The flask is then covered with a plastic cap and shaken at about 180 rpm for 60 min of precipitation reaction. Final pH may be measured using a CORNING pH/ion meter 450 (Laboratory Equipment, UK), and 12 ml of sample solution may be taken from the flask and immediately centrifuged at 3400 rpm for 15 min with a Cole-Parmer centrifuge. The supernatant of each centrifuged sample may be diluted by 10-50 fold for phosphate analysis by Technicon. After sampling for P analysis, the remaining solution in the reaction flask may be used for determination of solids yield and total dissolved solids (TDS) as described herein. The same proportion may be extrapolated to larger volume treatments. In certain embodiments, <5% (w/w) of wood ash may be added when wood ash is used in conjunction with lime milk treatment.

Although lime-based phosphate precipitation process does not necessarily reduce the ammonia content in the bio-waste per se, increased contact with air during solution transferring and larger head space in the settling column do promote loss of a considerable amount (e.g., 10-20%) of ammonia, depending on such factors as the lime reaction pH, agitation strength, and time. Such ammonia content loss could reduce the load for the ammonia air stripping tower, and consequently reduce the required air flow rate of the stripping tower.

Thus, in certain embodiments, in order to promote stripping of ammonia during the lime-based phosphate precipitation process, a negative-pressure generating device (such as a fan) may be installed on the top of the lime precipitation reactor to help strip a significant amount of ammonia out of the aqueous solution.

After phosphate precipitation, if centrifugation is used to effect solid-liquid separation, certain centrifugation aids may be used to aid more efficient precipitation removal/recovery. For example, low-cost materials such as wood ash (WA, e.g., about 50 g/L), fly ash (FA, e.g., about 50 g/L), hydrated lime powders (HL) and sawdust (SD, e.g., about 20 g/L) may be used as centrifuging aids. Hydrated lime (Ca(OH)₂) is preferably used, at a dose of about 25 g/L. These centrifuging aids may be added to the liquid with solid suspension, and the entire contents are shaken or mechanically stirred for a specified period of time (e.g., 10-60 min) before centrifugation. A 2% of wood ash may be used to pre-adjust pH in order to reduce the lime requirement and increase P value in the lime settlement.

Centrifugation may be carried out using any art-recognized equipment, including batch centrifuge and continuous centrifuge. If desired, the supernatant of the centrifugation can be colleted for measuring total solids (TS) and total dissolved solids (TDS). The total suspended solids (TSS) is calculated as the difference between TS and TDS.

### Ammonia Stripping

Like many other bio-waste materials, the anaerobic digestate is rich in the nutrient element nitrogen (N), which partly originates from degradation of N-rich proteins, peptides, and amino acids present in the organic waste material. A significant portion (if not the majority of) the element nitrogen exists in the digestate as ammonia (NH₃). If not properly extracted, the presence of ammonia in natural or industrial wastewater can cause significant environmental concern, because Nitrogen is an essential nutrient for growth of organisms in most ecosystems, and therefore is a major cause of eutrophication.

Aqueous ammonia exists in equilibrium with its gaseous counterpart in accordance to Henry's law:

NH₄⁺(aq)→H⁺+NH₃(aq)→NH₃(g) (Eq. 1)

The equilibrium between the un-ionized form (NH₃) and ionized form (NH₄⁺) in the aqueous solution depends on the pH and temperature. As pH increases, the equilibrium in Equation 1 shifts toward the right-hand side (gas). At pH above 7, the amount of NH₄⁺ decreases significantly with an increase in temperature. It is apparent that at a pH lower than 7, ammonia exists essentially in NH₄⁺ form regardless of the temperature. This, in turn, disfavors the ammonia stripping process.

Ammonia removal from wastewater can generally be achieved through physico-chemical, biological means, or a combination of chemical and biological means. The technologies developed for ammonia removal mainly included biological denitrification, air stripping, steam stripping, selective ion exchange, membrane separation, and breakpoint chlorination (Reeves, Journal WPCF, 44: 1895-1908, 1972; US EPA, Prepared by Gordon Culp, EPA-625/4-74-008, 1974; & USEPA, Nitrogen control. Technomic Publishing Co., Inc., Lancaster, USA. 1994, all incorporated herein by reference). The first two systems gained wide applications in sewage treatment, while the others were applied to more specific cases. The choice of a particular ammonia removal route may depend on the nature of the wastewater to be treated. For example, biological denitrification is hindered by low-temperature environments, the absence of carbonaceous compounds in suitable amount and the presence of toxic compounds. Ion exchange can have severe drawbacks when interfering ions are present. Breakpoint chlorination is generally too expensive for practical application unless the initial ammonia to be removed is very low, because of high costs and problems connected to the presence of unconverted chlorine in the treated water.

Ammonia stripping may also be achieved through commercial units, such as those from Revex Technologies Inc. (RTI, Houston, U.S.). RTI developed a unique gas-liquid contactor that is designed for high efficiency ammonia stripping. Several trials of ammonia stripping from aqueous solution containing 800-2400 mg NH₃—N/L were conducted in the RTI units at temperatures between 20 and 40° C. The experimental liquid and gas flow rates were approximately 17 and 280 L/min, respectively. The pH value of the ammonium solution was controlled at a level>10.9. Ammonia removal efficiency less than 15% was observed in a 10-min circulation.

Ammonia stripping may further be achieved through using engine exhaust gas, or other similar “waste gas” that is rich in CO₂, and preferably of high temperature (e.g., higher than 40, 50, 60, 70, 80, 90, 100° C. or more). Such gas stream is beneficial for ammonia stripping, partly because of the heat, the potential to reduce pH by the CO₂ rich gas, and the added benefit of mitigating greenhouse gas emission through fixing CO₂ in the gas stream.

Any of the above-referenced methods may be and are contemplated to be adapted for use in element N recovery in the instant invention.

As used herein, the term “ammonia stripping” generally refers to recovery of the nutrient element nitrogen (N) in its various forms, including (but not limited to) its gaseous form (i.e., the NH₃ gas), the various NH₄⁺ salts, or other N-containing chemical forms. In certain embodiments, the recovered nitrogen element is in gaseous form. In certain other embodiments, the recovered nitrogen element exists in one or more NH₄⁺ salts.

In certain embodiments, air may be used as a stripping agent. In certain embodiments, the carbon dioxide (CO₂) or carbon dioxide-enriched air or gas may be used as the stripping agent. The CO₂-enriched air or gas, such as those from an anaerobic digester, from an ethanol plant, or from combustion of biogas, is preferably high in temperature (e.g., >40° C., preferably >50, 60, 70, 80, 90, 100° C. or more). High-temperature CO₂-enriched gas is one of the major by-products from ethanol production plants, which may be integrated with the anaerobic digestion system that generates the anaerobic digestate.

NH₃ and CO₂ could be stripped out simultaneously from aqueous solutions. Because the solubility of CO₂ in water is much smaller than that of NH₃, the CO₂ stripping rate is two orders of magnitude higher than that of NH₃. The gas-liquid equilibrium studies in the NH₃—CO₂—H₂O system show that with increase of CO₂ in water, the CO₂ partial pressure significantly increases while the NH₃ partial pressure slightly deceases.

Applicants' prior work has demonstrated that CO₂-enriched gas can strip NH₃ from aqueous solutions including digested manure effluents. This ammonia stripping process using CO₂-enriched gas is pH-dependent. The stripping efficiency is relatively lower at pH 7.5, but the efficiency increases with increasing pH. The increase of the stripping efficiency is more pronounced from pH 7.5 to pH 9.5 than from pH 9.5 to pH 12.0. Thus in certain embodiments, the ammonia stripping process is carried out at a pH between 7.5-12.0, preferably between 8.5-9.5. In theory, any (strong or weak, organic or inorganic) acid or base may be used to adjust pH to provide the desired pH range. Preferred pH adjusting agents include various forms of lime, HCl, NaOH, H₃PO₄, etc.

Applicants' prior work has also demonstrated that temperature significantly affects the efficiency of ammonia stripping. The efficiency is quite low at about 10° C., but it significantly increases with rising temperature. For example, in a previous experiment, the efficiency for a 30-minute stripping was 4%, 15%, 33% and 73% for temperatures of 10, 25, 40 and 60° C., respectively. In addition, the influence of temperature is greater than that of pH. Increasing temperature can reduce the stringency of the required pH ranges, thus reducing alkaline consumption. Therefore, in certain embodiments, ammonia stripping is carried out at an elevated temperature (e.g., 30° C. or above, preferably ≧40° C. or 45° C., up to 60° C.) to increase the stripping efficiency as well as to reduce alkaline consumption.

Applicants' prior work has further demonstrated that CO₂ concentration in the stripping gas also affects ammonia-stripping efficiency. The efficiency decreases with increasing CO₂ concentration, likely due to the NH₃ partial pressure reduction in the presence of CO₂ in solution. For example, in a prior experiment, the efficiency for a 30-min stripping carried out at 25° C. and pH 9.5 was 43%, 31%, 27% and 21% for CO₂ concentrations of 0%, 14%, 25% and 75%, respectively. However, Applicants discovered that CO₂ concentration shows less effect on ammonia stripping efficiency in digested manure effluents compared to chemical solutions containing ammonia. This is likely due to the reduction of free CO₂ in solution owing to the formation of carbonate precipitates from metal ions, such as Ca and Mg, existing in manure effluents. Although a higher CO₂ content in the stripping gas decreases pH and thus lowers the ammonia stripping efficiency, a reasonably higher stripping efficiency can be maintained in spite of using CO₂-enriched gas if stripping is carried out at a relatively high temperature.

Thus in certain embodiments, CO₂ concentration in stripping gas is ≦50%, preferably no more than 25%. However, a higher CO₂ concentration may be used when the stripping gas is coupled with a higher stripping temperature.

In certain embodiments, the gas/liquid ratio≧1000 (m³/m³) at 40° C. or above is required. A lower gas/liquid ratio can be used if a higher stripping temperature is used.

In certain embodiments, the concentration of the ammonia nitrogen content in the starting bio-waste water (e.g., anaerobic digestate) is about 1000-4000 mg NH₃/L, about 1200-2400 mg NH₃/L, about 1200-1500 mg NH₃/L, about 2000-3000 mg NH₃/L, or about 2500 mg NH₃/L. The total solids (TS) content of the starting bio-waste water (e.g., anaerobic digestate) is preferably no more than 2%, 1.5%, 1.0%, or 0.6%. The pH value of the starting bio-waste water (e.g., anaerobic digestate) is preferably between about 9-12, or about 9.5-11.

Overall, Applicants have shown that CO₂ (especially hot CO₂-enriched gas that is a by-product of ethanol plants) can be used for ammonia stripping under optimal pH and temperature conditions. In addition, Applicants have also shown that CO₂ can be used for pH adjustment of digested manure effluents, lime-treated effluents, or other bio-waste liquids.

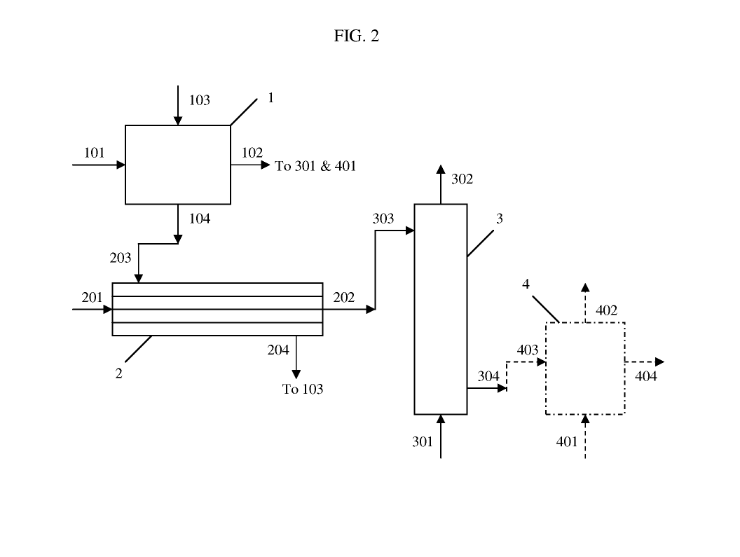

Thus in an exemplary set up, as shown in FIG. 2, hot CO₂ or flue gas 101 may be directed to enter a direct heat exchanger 1 to contact feed water 103. The heated water 104/203 can then enter an indirect heat exchanger 2 to heat up manure effluent (maybe lime-treated and settled) 201. The cooled circulating water 204 from the indirect heat exchanger 2 returns to the direct heat exchanger 1 as the feed water 103. On the other hand, a part of the cooled CO₂ or flue gas 102 from the direct heat exchanger 1, is then directed to the ammonia stripping tower 3 as stripping agent 301, and contacts the heated manure effluent 202/303 (which comes from the indirect heat exchanger 2). The water stream is circulated between the direct heat exchanger 1 and indirect heat exchanger 2. Although continuously contacting CO₂ gas 101, this circulating water should hold a constant pH of about 6, due to the limited solubility of CO₂ in water. The CO₂ content of the incoming gas 101 should not significantly change after contacting water 103 in the direct heat exchanger 1 under a steady-state operation. The NH₃-stripped liquid stream 304/403 coming out of the stripping tower 3 should have a lowered pH. If the pH value in this stream 304/403 needs further adjusting, another optional gas-liquid contactor 4 may be installed downstream of the stripping tower 3, for mixing some cooled CO₂ gas 102, shown as 401, with the stripped effluent 304/403. The pH-adjusted effluent 404 then exits the gas-liquid contactor 4, so does the CO₂-reduced gas 402.

In this typical set up, the heat carried by the incoming CO₂-enriched gas is first transferred to the incoming bio-waste water (e.g., phosphate-reduced water, such as the lime-treated and settled anaerobic digestate) through a heat-exchange medium (e.g., recycling water) to raise the temperature of the nitrogen-rich bio-waste water before the cooled gas directly contacts the bio-waste water in the ammonia stripping tower. This is largely based on the experimental finding that raised temperature greatly facilitates ammonia stripping efficiency, while simultaneously reducing the negative impact of potential pH reduction by CO₂ in the nitrogen-rich waste water.

The cooled CO₂-enriched gas can also be used optionally as a downstream pH adjuster for the out-coming ammonia-stripped wastewater. For example, the CO₂ requirement for adjusting pH in lime-treated manure effluent from pH 10.2 to pH 7.9 is approximately 5 g CO₂/L effluent. Based on this ratio, at least 1000 kg CO₂/day is required for pH adjustment of 200-m³/day lime-treated effluents in an anaerobic treatment plant. If CO₂ gas is supplied from an ethanol plant, the production capability needs to be at least 1113 L ethanol/day or 406,270 L/year. If CO₂ gas is from the exhaust of biogas combustion, which contains about 14% CO₂, the volume of the exhaust needs to be at least 3636 m³/day. This may count towards CO₂ credits as the CO₂ gas has been fixed or stored.

### Ammonia Sorption

The stripped NH₃ gas may be collected and purified in its gas form. Alternatively, NH₃ in the NH₃-enriched air may be further absorbed into a solid matrix. For example, the solid portion separated from the anaerobic digestate (centrifuged digested manure solids, or “CDM solids”) may be used to absorb NH₃, resulting in N-enriched bio-solids that may be used as fertilizer. In certain embodiments, the CDM solids are further impregnated with an acid, such as H₂SO₄, to increase its ammonia sorption capacity. In certain embodiments, CaSO₄ may be added to generate the sulfur-containing CDM solids, which may help to increases not only the concentration of sulfate, but also the concentration of phosphate in the bio-solid.

Applicants have shown that the CDM solids have ability to sorb gaseous ammonia from an air-NH₃ mixture. The capacity is approximately 53 g NH₃/kg dry solids at a moisture content of about 64%. Applicants found that moisture content in the biosolids plays an important role in ammonia sorption. Increasing the moisture content almost linearly increases the ammonia sorption on biosolids. After sorption, however, the total nitrogen content in the biosolids decreases with drying, even at room temperature. This nitrogen release is closely related to the moisture loss during drying. For instance, the total nitrogen content in biosolids can change from 53 to 30 g NH₃/kg dry solids when moisture content changes from 64% to 10% after 24-hour drying at room temperature. While not wishing to be bound by any particular theory, available data suggests that ammonia absorption by water is likely the key mechanism for ammonia sorption on biosolids under the tested experimental conditions.

Packing density of biosolids in the sorption column also affects ammonia sorption capacity. A high packing density is usually associated with a high ammonia sorption capacity.

Addition of H₂SO₄ in the CDM biosolids can enhance their ammonia sorption capacity. However, total nitrogen content in those ammonia-sorbed biosolids also decreases with air drying at room temperature. Ammonia sorption capacity increases with increasing H₂SO₄ load, and ammonia loss from the ammonia-sorbed biosolids during drying also decreases with increasing H₂SO₄ load. The added H₂SO₄ likely enhances ammonia sorption through chemical formation of ammonium sulfate.

Ammonia sorption capacity on granulated biosolids is slightly smaller than that of original CDM solids at the same moisture content. This is likely caused by less penetration and distribution of ammonia through the granulated dense biosolids particles.

During air drying of the ammonia-sorbed biosolids, about half of the total nitrogen escaped from the solids. However, addition of sulfuric acid to the CDM solids enhances ammonia sorption. The incubation of the sulfur-containing CDM solids help to increases not only the concentration of sulfate, but also the concentration of phosphate.

### Water Treatment

A large portion of the bio-waste materials consists of water, which may be recycled for different uses, depending on the requirement for the quality of the resulting water.

For example, the liquid portion after the initial solid-liquid separation may be of high enough quality to be used directly in certain processes, such as ethanol fermentation or culture of algae and other microorganisms, without the need for any further treatment, although certain (more purified) fractions of this liquid portion may perform better in the same biological process.

Other uses of the recycled water may require one or more additional steps of treatment to further improve quality before the treated water can be used as, for example, livestock drinking water.

One exemplary treatment is ultrafiltration, which may be carried out using standard equipments in the art, and which may be commercially available.

Ultrafiltration (UF) is a variety of membrane filtration in which hydrostatic pressure forces a liquid against a semi-permeable membrane. Suspended solids and solutes of high molecular weight are retained, while water and low molecular weight solutes pass through the membrane. This separation process is used in industry and research for purifying and concentrating macromolecular (10³-10⁶ Da) solutions, especially protein solutions. Ultrafiltration is not fundamentally different from microfiltration or nanofiltration, except in terms of the size of the molecules it retains. Mostly, ultrafiltration is applied in cross-flow mode and separation in ultrafiltration undergoes concentration polarization.

Several different membrane geometries may be used in UF. Spiral wound module consists of large consecutive layers of membrane and support material rolled up around a tube, which maximizes the surface area. It is less expensive, but may be more sensitive to pollution. In the tubular membrane setting, the feed solution flows through the membrane core and the permeate is collected in the tubular housing. This is generally used for viscous or bad quality fluids, such as anaerobic digestate. The hollow fiber membrane modules contain several small (0.6 to 2 mm diameter) tubes or fibers. The feed solution flows through the open cores of the fibers, and the permeate is collected in the cartridge area surrounding the fibers. The filtration can be carried out either “inside-out” or “outside-in.” Ultrafiltration, like other filtration methods, can be run either as a continuous or batch process.

The permeate of the ultrafiltration may be subjected to one or more additional rounds of UF process to obtain progressively purer recyclable water, while the concentrate maybe combined with other waste water for further treatment, such as UF, in order to maximize the recoverable water.

Ultrafiltration permeates may be subject to additional treatment such as reverse osmosis. Reverse osmosis (RO) is a filtration method that removes many types of large molecules and ions from solutions by applying pressure to the solution when it is on one side of a selective membrane. The result is that the solute is retained on the pressurized side of the membrane and the pure solvent is allowed to pass to the other side. In order to be “selective,” this membrane should not allow large molecules or ions through the pores (holes), but should allow smaller components of the solution (such as the solvent, e.g., water) to pass freely.

Reverse osmosis is most commonly known for its use in drinking water purification from seawater, removing the salt and other substances from the water molecules. This is the reverse of the normal osmosis process, in which the solvent naturally moves from an area of low solute concentration, through a membrane, to an area of high solute concentration. The process is similar to membrane filtration. However, there are key differences between reverse osmosis and filtration. The predominant removal mechanism in membrane filtration is straining, or size exclusion, so the process can theoretically achieve perfect exclusion of particles regardless of operational parameters such as influent pressure and concentration. Reverse Osmosis, however, involves a diffusive mechanism so that separation efficiency is dependent on solute concentration, pressure and water flux rate.

The membranes used for reverse osmosis have a dense barrier layer in the polymer matrix where most separation occurs. In most cases the membrane is designed to allow only water to pass through this dense layer while preventing the passage of solutes (such as salt ions). This process requires that a high pressure be exerted on the high concentration side of the membrane, usually 2-17 bar (30-250 psi) for fresh and brackish water, and 40-70 bar (600-1000 psi) for seawater, which has around 24 bar (350 psi) natural osmotic pressure that must be overcome.

If necessary, the permeate of RO may be subjected to additional rounds of RO process to further improve water quality. Ion exchange may be used downstream of RO to remove additional undesirable dissolved ions in the RO permeate.

The concentrate of RO may contain higher levels of ammonia, especially when ammonia stripping has not been carried out before the series of water purification steps. Such concentrate may be used in ammonia stripping steps described above.

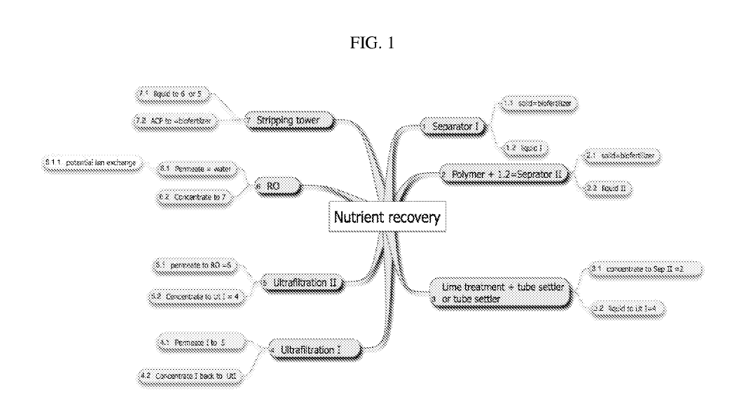

FIG. 1 shows a schematic view of a representative nutrient recovery process according to one embodiment of the invention. Note that the numerical designations do not necessarily represent the sequence of operation in all related embodiments, such that a higher number step may be carried out before a lower number step in certain related embodiments.

According to this depicted embodiment, a solid portion is separated from a liquid portion of the bio-waste material using a Seperator I (1). The solid portion (1.1) may be used as biofertilizer, while the liquid portion (1.2) may be mixed with one or more polymers of the invention in Seperator II (2), which may or may not be the same as Seperator I (1). Again, solid (2.1) from Seperator II (2) may be used as bio-fertilizer, either alone or in a mixture with solid (1.1). Liquid II (2.2) from Seperator II (2) may be subjected to downstream treatment, such as lime treatment to remove phosphate.

One or more additives may be added in this process, including Al or Fe chemicals, wood ash, or gasification by-products, to facilitate solid-liquid separation.

In a preferred embodiment, however, polymer is added prior to or simultaneously with the solid-liquid separation step in Seperator I (1) (and there will be no need for Separator II).

Separators I and II may be any of art recognized solid-liquid separators or dewatering devices, such as screw press, rotary press, filter press, belt filter press, various kinds of centrifuges (including solid-bowl decanter), electrodewatering, etc.

Separated liquid II (or the liquid portion of the polymer-assisted solid-liquid separation) may be subjected to treatment designed to remove/recover phosphate, such as lime-based phosphate recovery, or Mg salt based struvite preparation as described herein above (3). After lime precipitation, the content may optionally be settled in a tube settler, in which case the separated liquid (3.2) may be used directly in an integrated bio-production facility such as ethanol plant of algae-based bio-production module. Alternatively, the separated liquid (3.2) may be subjected to one or more rounds of ultrafiltration (4 and/or 5). The concentrate may be pooled with the sludge equivalent to those in Separator II (2) for repeat solid-liquid separation.

If lime treatment is used, the added benefit of raised pH is conducive to downstream ammonia stripping. Thus the lime treatment step is preferably carried out before ammonia stripping.

One or more steps of ultrafiltration may be carried out to further purify water (4 and 5). The permeate (4.1 and 5.1) and concentrate (4.2 and 5.2) of UF may be subjected to additional rounds of UF, or reverse osmosis (6). RO concentrate usually contains high level of ammonia, and is best suited for ammonia stripping and/or sorption in a stripping tower (7). The RO permeate (6.1) may be further purified by, for example, ion exchange (6.1.1) to improve water quality.

After ammonia stripping (7), the liquid portion (7.1) may be recycled back for further water purification (UF and/or RO), while the ammonia gas may be collected and purified as a gas, or be incorporated into a solid fertilizer through ammonia sorption (7.2).

### EXAMPLES

With the general concept and several preferred embodiments of the invention described above, the examples below are provided to further illustrate specific aspects of the invention. While general teachings in the examples are considered applicable to the described invention, specific limitations are not intended to be limiting.

### Example 1

### Cationic Polymer Improves Solid Removal During Centrifugation of Digested Manure

Several CIBA® ZETAG® cationic polymers, such as ZETAG 7645 and ZETAG 7623, were used as flocculants for flocculation of digested manure slurry. These polymers are non-toxic ultra high molecular weight cationic polyacrylamide flocculants. Their typical structure is shown in the formula below. For this experiment, a polymer stock solution containing about 1% of polymer by weight was further diluted to 0.2% before its use in bench tests. Alternatively, the polymer solution (0.2% by weight) can be made by dissolving 40 g of ZETAG® 7623 into 20 L of tap water.

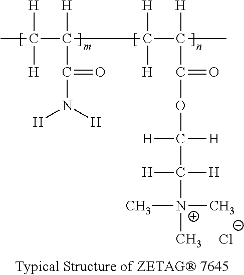

Two types of flocculation tests were conducted in this experiment: the batch jar flocculation test, and the pilot centrifuging test. In the batch jar test, 200 mL of uncentrifuged digested manure slurry was taken into a 500-mL beaker, and then a certain amount of polymer solution was added. After immediately mechanical agitation for about 10-60 seconds, the sample was visually inspected for floc formation and water clarity. In the pilot tests using pilot decanting centrifuge, raw digested manure slurry was centrifuged with or without addition of polymer solution. The centrifuge feed pump was operated at 3.4 L/min., and the polymer feed pump was operated at three different flow rates: approximately 0.3, 0.5, and 1.2 L/min. In the individual centrifuging tests, polymer was added at two different locations: before or after the centrifuge feed pump. The raw digested manure slurry and centrifuged liquids were sampled for measurements of total solids (TS) and total dissolved solids (TDS). The value of total suspended solids (TSS) was calculated as the difference between TS and TDS.

Different cationic polymers from high ionic charge to low ionic charge were tried in tests using raw digested manure slurry at dosages approximately from 100 to 400 mg/L. Compared to other ZETAG® products tested, ZETAG® 7623 was found to have a better flocculation result of the raw digested manure slurry.

When ZETAG® 7623 was used at a polymer dosage of 250 mg/L, the raw slurry was flocculated in about 5 to 20 seconds, and some clarified water was observed on the top of the flocculated solids. At a polymer dosage of 300 mg/L, the solids from the slurry were flocculated faster, and larger chunks of flocculated solids were observed. The solution clarity was even better than that from the prior test using 250 mg/L polymer. A polymer (ZETAG® 7623) dosage of about 250-300 mg/L appears to be best suited for flocculation of the exemplary digested manure slurry with a suspended solids content of approximately 8%. Optimum polymer concentration for other cationic polymers can be similarly determined using the method described herein.

The results of solid content measurement in an exemplary experiment, in which several raw and centrifuged samples were measured, are listed in Table 1 below.

TABLE 1
Centrifuging Experimental Conditions and Solid Content Measurement

| | | Polymer | Polymer | Effluent | | | | | |
|---|---|---|---|---|---|---|---|---|---|
| Sample | Sample | feed | feed rate | feed rate | TS | TDS | TSS | PO₄³⁻ | NH₃ |
| ID | description | position | (L/min) | (L/min) | (%) | (%) | (%) | (mg/L) | (mg/L) |
| 1 | Raw digested | | | | 8.56 | 1.55 | 7.02 | 295.8 | >2000 |
| 2 | Centrifuged with | | | 3.4 | 3.76 | 1.58 | 2.18 | 219.3 | 1646 ± 34 |
| | no polymer | | | | | | | | |
| 3 | Centrifuged with | Before | ~1.2 | 3.4 | 1.77 | 1.18 | 0.597 | 100.2 | 1290 |
| | polymer | pump | | | | | | | |
| 4 | Centrifuged with | After | ~0.5 | 3.4 | 1.79 | 1.20 | 0.585 | 102.1 | 1310 ± 34 |
| | polymer | pump | | | | | | | |
| 5 | Centrifuged with | After | ~0.3 | 3.4 | 2.08 | | | | |
| | polymer | pump | | | | | | | |
| 6 | Bulk solution* | | 0.3-1.2 | 3.4 | 1.86 | | | 138.3 | 1318 |
| | centrifuged with | | | | | | | | |
| | polymer | | | | | | | | |

*Bulk solution was collected from Run# 3, 4, and 5.

As shown in the data above, the raw digested manure slurry had a total solid (TS) content of about 8.56%. In the separated liquid portion after centrifugation without polymer addition, the measured total solid (TS) content was reduced to about 3.76%. This ˜5% absolute TS reduction is largely due to a drop in the total suspended solid (TSS) content (compared Sample 1 and Sample 2 under the column TSS(%)—a reduction from 7.02% to 2.18%). As expected, centrifugation does not apparently reduce the total dissolved solid (TDS) content (compare Samples 1 & 2 under the TDS (%) column).

Addition of polymer before centrifugation (Samples 3-5) further reduced TS content in the separated liquid portion to about 1.8%-2.1%. This number was slightly reduced further with an increased polymer dosage (data not shown). Interestingly, this ˜2% absolute drop in TS (%) was largely due to a reduction of total dissolved solid (TDS) content (compare Sample 2 with Sample 3 or 4, under the column TSS (%)—a dramatic reduction from 2.18% to about 0.6%), and to a smaller extent, due to a reduction of total suspended solid (TSS) content (compare the same samples—a small yet significant reduction from 1.58% to about 1.2%).

To summarize, the calculated total suspended solids (TSS) content was about 7.0% in the raw digested sample, about 2.2% in the liquid portion of the sample centrifuged without polymer addition, and only about 0.6% in the liquid portion of the sample after polymer-assisted centrifugation. Furthermore, solid-liquid separation does not appreciably reduce the 1.58% total dissolved solid (TDS) content in the absence of polymer addition, while polymer addition before centrifugation has the added benefit of further reducing TDS. Overall, polymer addition can significantly improve solid-liquid separation and reduce total suspended solids (TSS) and total dissolved solids (TDS) in effluents.

Perhaps more significantly, the sequence of polymer addition and solid-liquid separation appear to be important for the above outcome. In a related experiment, two types of cationic polymers, ZETAG® 7623 and ZETAG® 7645, were tested for flocculating a previously centrifuged digested manure effluent at similar dosages from 50 to 350 mg/L. Surprisingly, no good flocculation was observed. While not wishing to be bound by any particular theory, this result suggests that the biofibers in the digested manure slurry may play an important role in the flocculation of manure slurry. The biofibers most possibly bridge the adjacent suspended particles and assist the formation of a more three-dimensional reticulated floc structure. The implication of this observation is that, for more efficient removal of suspended solids, polymer should be added to the uncentrifuged manure slurry, rather than the centrifuged manure effluent, before mechanical solid-liquid separation.

### Example 2

### Cationic Polymer Improves Nutrient Removal During Centrifugation of Digested Manure

This examples shows that cationic polymer not only facilitates solid removal, but also unexpectedly facilitates precipitation/recovery of certain nutrients, such as phosphate and nitrogen, during the solid-liquid separation process.

In the experiment above, ammonia and phosphate concentrations were also measured for the above-mentioned samples as shown in Table 1. Unexpectedly, the NH₃ and PO₄³⁻ concentrations in the polymer-assisted centrifuged samples were approximately 20% and 50% lower than those in the polymer-free centrifugation sample. This indicates that the addition of polymer also facilitates NH₃ and PO₄³⁻ removal from effluents during centrifugation.

### Example 3

### Reduction of Settled Solids after Lime Treatment in Cationic Polymer-Assisted Solid-Liquid Separation

After polymer-assisted solid-liquid separation conducted under conditions similar to that of Example 1, the separated liquid portion was further subjected to lime treatment. The lime-treated samples were then poured into different glass tubes for settling. An exemplary glass tube used in this experiment was 37 mm in internal diameter and 295 mm in height (1:8 diameter to height ratio). Ammonia concentration in sample solutions was measured using an ORION ammonia probe. Phosphate concentration was determined by ion chromatography using Dionex ICS1000.

The results of lime treatment for samples after polymer-assisted centrifugation are shown in Table 2. The lime dosage used was between 0 to 20 g/L. The raw centrifuged effluent had a pH of about 7.54. In general, the pH in the lime-treated effluent increased with increasing lime dosage. For instance, pH was 9.40 for a sample treated with a lime dosage of 5 g/L, and 12.13 for sample treated with a lime dosage of 10 g/L.

TABLE 2
Results of lime treatment on polymer-assisted centrifuged manure effluents

| | | | | Volume | | | | |
|---|---|---|---|---|---|---|---|---|
| Sam- | Lime | | PO₄⁻³ | ratio | Tur- | | | |
| ple | dosage | Final | conc. | (Bottom/ | bidity | TS | TDS | TSS |
| ID | (g/L) | pH | (mg/L) | top) | (ntu) | (%) | (%) | (%) |
| 1 | 0 | 7.54 | 138.3 | | 3010 | 1.856 | | |
| 2 | 5 | 9.40 | 27.5 | 7.8% | 3710 | 1.759 | | |
| 3 | 10 | 12.13 | <1 | 18.6% | 2860 | 1.565 | 1.20 | 0.365 |
| 4 | 15 | 12.25 | <1 | 20.4% | 3270 | 1.569 | | |
| 5 | 20 | 12.34 | <1 | 22.2% | 1950 | 1.555 | | |

* PO₄³⁻, TS, TDS were measured in top solutions after 2-day settling.

As a result of lime treatment, the residual PO₄³⁻ was reduced from about 138.3 mg/L to about 27.5 mg/L with 5 g/L lime treatment, and further reduced to below 1 mg/L with a lime dosage of ≧10 g/L. The total solids content was only slightly decreased with the increasing doses of lime. The remaining TS, TDS and TSS in the lime treated effluent at the lime dosage of 10 g/L are 1.57%, 1.20% and 0.37%, separately.

It was observed during the experiment that the majority of solids in the settling tubes settled down in about 1-2 hours. As shown in Table 2, the volume ratio of the bottom slurry over the top solution is from 8% to 22% at the lime dosage of between 5 to 20 g/L. This ratio is much higher (e.g., approximately 100%) for the similar treatment using polymer-free centrifuged manure effluents. This result suggests that the settled solids portion from lime treatment using polymer-assisted centrifuged effluents becomes smaller compared to that using polymer-free centrifuged effluents.

After lime treatment and solid precipitation in a settling tank, the top liquid portion from the settling tank may be further treated to recover ammonia and/or recyclable water in downstream treatments. For example, the top liquid portion may be directed to an air-stripping tower for ammonia stripping/recovery, or it may be filtered through microfiltration, ultrafiltration, reverse osmosis, or ion exchange. The effluent from the stripping tower may go to a lagoon or clarifier for further settling and pH adjusting. The resulting clarified water may be used in agriculture, irrigation, or for preparing manure feed to digesters. The bottom settled slurry from the settling tank may be recycled back to the solid-liquid separator (e.g., centrifuge) to be mixed with and centrifuged again with the anaerobic digestate from the anaerobic digester.

The polymer dosage for solid-liquid separation is normally based on the amount of dry matter (DM) in the wastewater to be treated. A typical polymer dosage is about 4-10 kg/ton DM. The dry matter in the digested manure slurry (anaerobic digestate) before centrifuge is about 80 kg/m³. Thus, if a polymer dosage of 300 mg/L is used in the process for enhancing solid-liquid separation (e.g., centrifugation), the dosage based on the dry matter is about 3.75 kg/ton DM.

Due to the suspended solids reduction by the polymer-assisted solid-liquid separation (e.g., centrifugation), the lime consumption can be reduced from a typical 20 kg/m³ to about 10 kg/m³. The corresponding cost of lime is thus reduced by about half. The savings from the reduced lime can roughly compensate the polymer cost. Table 3 below is an exemplary cost estimation based on a typical market.

TABLE 3
Cost estimation of flocculants and coagulants

| Item | Unit | Value |
|---|---|---|
| Effluent flow rate | m³/day | 133 |
| Polymer price | $/kg | 5 |
| Polymer dosage | g/m³ | 300 |
| Unit polymer cost | $/m³ | 1.5 |
| Daily polymer cost | $/day | 199.5 |
| Hydrated lime price | $/kg | 0.14 |
| Lime dosage | kg/m³ | 10 |
| Unit lime cost | $/m³ | 1.4 |
| Daily lime cost | $/day | 186.2 |
| Unit chemical cost | $/m³ | 2.9 |
| Daily chemical cost | $/day | 385.7 |

The examples above demonstrate the many potential benefits of using polymer for flocculation of bio-waste water, such as digested manure slurry. It improves dewatering efficiency, decreases centrifuged effluent solids and bottom slurry volume in the downstream (lime) settling tank. Further, it enhances colloidal retention in sludge coke (biosolids), leading to reduced BOD/COD and other nutrients in effluents.

### Example 4

### Coagulation of Digested Manure Effluents with Different Coagulants

Coagulation of digested manure effluents with different coagulants or their combinations was extensively conducted in jar testing. The first sets of coagulation experiments used alum (Al₂(SO₄)₃) and lime with the dosages of 0-3 g alum/L and 15-25 g hydrated lime/L. Alum and lime were separately prepared as solution or lime milk. The treatment sequences included:
Alum first and then lime
Lime first and then alum
Alum and lime simultaneously

The following conclusions can be drawn from the results and observations:
Alum helps setting at the first few days.
Alum alone helps coagulation, but is not effective to reduce the bottom slurry volume after settling.
After setting for 3-5 days, lime treatment is almost as good as the treatment using both alum and lime.

The second sets of coagulation experiments used a combination of alum, lime and praestol- and percol-type polymers.
Lime plus polymers at a fixed lime dosage (15 g hydrated lime/L) and 0-1500 mg polymer/L.
Alum and lime plus polymers at a fixed alum and lime dosage (1 g alum/L and 15 g hydrated lime/L) and 0-1500 mg polymer/L.

It was found that there was no improvement of settling by adding these types of polymers.

The third sets of coagulation experiments were large-scale lime treatment of digested manure effluents. The experiments were conducted in a 200-L tank with a hydrated lime dosage of approximately 20 g/L. After adding lime milk, the centrifuged digested manure effluent was mechanically stirred for 60 min at 10-13° C. and then settled in the tank. Coagulation and settling in this large tank was comparable but somewhat less efficient as the previous small batch experiments, partly due to higher solids content in the manure effluent tested, insufficient mixing, and/or a lower reaction temperature.

### Example 5

### Powder Forms of Low-Grade Lime for Phosphate Removal

High quality lime-based agents having high dissolved calcium is usually preferred as a phosphate removal agent. However, certain low-grade lime-based agents may also be used in certain situations, as demonstrated in this experiment.

The powder forms of limekiln dust and granulime as well as hydrated lime were used in these tests. The results of phosphate removal efficiency and final solution pH after reaction were obtained. It was found that P removal efficiency with limekiln dust is about 35%, while this efficiency is about 80% with hydrated lime when the lime dosage is 15 g/L. When the dosage of limekiln dust was increased to 30 g/L, the P removal efficiency increased only slightly to 36%. This lower P removal efficiency when using limekiln dust likely resulted from a low content of Ca(OH)₂ in the limekiln dust. This was also demonstrated by the lower final solution pH pertinent to the use of limekiln dust, in that the final pH was only 9.0-9.4 when using 15-30 g/L of limekiln dust. In contrast, the pH reached 11.5 when using 15 g/L of hydrated lime.

On the other hand, preliminary results showed that granulime was nearly completely ineffective for P removal from manure effluent. The corresponding pH was only 7.9-8.0 when using 15-30 g/L of granulime. This latter pH was considered too low for effective precipitation in the form of calcium phosphate.

The results of phosphate removal using milk forms of limekiln dust and hydrated lime were also obtained. At a lime dosage below 30 (g/L), the P removal efficiency with a milk of limekiln dust was lower than that with a milk of hydrated lime. At a limekiln dust dosage of 30 (g/L) or higher, this efficiency reaches 100%, similar to the results obtained at a hydrated lime dosage of 15 or higher. These results indicated that using limekiln dust in a form of milk can achieve a similar performance of P removal as does using hydrated lime. Of course, the required dosage of limekiln dust was higher than that of hydrated lime. It was roughly estimated that the required dosage for limekiln dust was about 2-2.5 times of that for hydrated lime.

In comparison to the results with limekiln dust powders, at the dosage above 15 (g/L), the P removal efficiency with powders is clearly lower that with using milk.

The final solution pH reached 12 at a dosage of 15 g/L with hydrated lime milk. When using a milk of limekiln dust, however, the pH increased with increasing lime dosage and reached 12 at the dosage of 45 g/L. In contrast, the pH changed little and was only 9.4 at a dosage of 45 g/L when using powders of limekiln dust. Obviously, the lower pH resulted from less available Ca(OH)₂ when the powders were used.

Different grades of lime (at a dosage of 15 g/L) were also tested to determine their ability to serve as centrifuging aids. Compared with the results of no lime addition, only addition of hydrated lime as centrifuging aid showed certain reduction of suspended solids (SS). This reduction might be caused by strong coagulation action of Ca(OH)₂. In contrast, either limekiln dust or granulime does not show any significant reduction of SS during centrifugation. The dissolved solids with addition of different limes were virtually at the similar level.

Overall, the experiments showed that limekiln dust (such as those obtained from Graymont Western Canada Inc.) can be used for phosphate removal from digested manure effluent, but it is less efficient than hydrated lime, mainly due to its lower available Ca(OH)₂ content. The powder form of limekiln dust is also much less efficient than its milk form.

The P removal efficiency increased with increasing limekiln dust dosage when a milk form was used. At a higher lime dosage, using limekiln dust in a milk form can achieve a similar performance of P removal as does using a milk form of hydrated lime. The required dosage for limekiln dust is approximately 2-2.5 times or higher than that for hydrated lime. Thus assuming that the required dosage of hydrated lime is 15-20 kg/m³ digested manure slurry, the required dosage of limekiln dust will be about 40 kg/m³ digested manure slurry.

Under the conditions tested, both limekiln dust and granulime (obtained from Graymont Western Canada Inc.) do not show significant ability to serve as a centrifuging aid for reducing suspended solids from digested manure slurry.

### Example 6

### Physical Means to Extract Phosphate from Digested Manure Solids

This experiment showed that a significant amount of phosphate in the digested cattle manure was associated with solids. Complete release of the phosphate to the aqueous phase is a slow process. Thus a significant amount of phosphate nutrients may be recovered by simple physical means, such as repeated extraction and centrifugation as described below.

The digested cattle manure used in the experiments was from a laboratory 80-L digester after 34-day anaerobic digestion at 55° C. with an initial 10% solids content. A representative extraction followed a procedure briefly described as below:

1) Centrifuge 250 mL of digested manure at 5000 rpm for 20 min.

2) Separate supernatant and measure its volume.

3) Add water equivalent to the separated supernatant into the remaining solids.

4) Shake the extracting solution at 150 rpm for 2 hours.

5) Centrifuge the extracting solution at 5000 rpm for 20 min.

6) Repeat steps 2) to 5) for 5 times.

7) Analyze phosphate concentration in the extracted supernatant.

Water extraction of digested manure solids

| | | Liquid | Solids | PO₄³⁻ | PO₄³⁻ | Ex- |
|---|---|---|---|---|---|---|
| | Sample | volume | weight | Conc. | weight | tract. |
| No. | treatment | (mL) | (g) | (mg P/L) | (mg P) | (%) |
| 0 | Raw digested | 160 | 90 (ml) | 213.33 | 34.13 | |
| | manure, | | | | | |
| | uncentrifuged | | | | | |
| 1 | Centrifuged | 144 | 110.79 | 56.47 | 8.13 | 26.04 |
| | (initial 250 ml) | | | | | |
| 2 | 1st extraction | 156 | 89.72 | 42.06 | 6.56 | 21.01 |
| | with 144 ml H₂O | | | | | |
| 3 | 2nd extraction | 149 | 83.84 | 38.79 | 5.78 | 18.51 |
| | with 156 ml H₂O | | | | | |
| 4 | 3rd extraction | 142 | 85.04 | 40.85 | 5.80 | 18.58 |
| | with 149 ml H₂O | | | | | |
| 5 | 4th extraction | 136 | 84.41 | 19.59 | 2.66 | 8.53 |
| | with 142 ml H₂O | | | | | |
| 6 | 5th extraction | 134 | 82.61 | 17.09 | 2.29 | 7.33 |
| | with 136 ml H₂O | | | | | |
| | Total extracted | | | | 31.23 | |
| | phosphate | | | | | |

### Example 7

### Struvite Precipitation

Raw cattle manure was obtained from the Highland Feeder. Two types of manure effluents, undigested and (anaerobically) digested, were used in experiments. The digested manure effluent was produced in-house through anaerobic digestion. Both manure effluents were centrifuged at 5000 rpm before used for nutrient recovery experiments. Different batches of manure effluents were used in the experiments, and the nutrient contents varied from batch to batch, 178-187 mg PO₄³⁻/L and 642-660 mg NH₃—N/L for undigested manure effluents, and 300-600 mg PO₄³⁻/L and 2300-3000 mg NH₃—N/L for digested manure effluents.

The following chemicals were used in this phase of experiments: MgO (97% min, BDH analytical grade, AnalaR), MgO (Baymag 96, −200 mesh), Mg(OH)₂ (95.0-100.5%, Fisher Scientific), MgCO₃ (40.0-43.5% as MgO, Fisher Scientific), MgSO₄.7H₂O (99.5% min, BDH analytical grade, AnalaR), MgCl₂.6H₂O (99.7%, J. T. Baker analyzed reagent), NH₄Cl (99.5%, BDH analytical reagent), KCl (99.0-100.5%, EM Science), and Na₂HPO₄ (99.0%, BDH assured analytical reagent).

Batch struvite precipitation experiments using manure effluents were conducted to evaluate different conditions including pH, amount of Mg addition, temperature and addition of different Mg salts. In batch experiments except kinetic runs, 100 ml of manure effluent was added in a 200-ml beaker (reactor) with a magnetic stirring and 60 minutes of the reaction time was used. If not specified, the experimental pH was controlled at 9.0 and the reaction temperature was 20° C. (room temperature). If not stated, the magnesium salt used in the experiments was 1 M MaCl₂ solution. In the kinetic experiments, 300 ml of manure effluent was used and sampled at 5, 15, 30 45 and 60 minutes after start of the experiments. For all experiments, a pH probe and a thermometer were set in the reactor for monitoring pH and temperature. For evaluation of temperature effects, the reactor was placed in a water bath which can well control temperature at a designated value±0.5° C.

Since ammonia content in the tested manure effluents was much higher than the phosphate content, the removed ammonia by struvite precipitation in the experiments without the addition of phosphate accounted only a small part of the total ammonia. Hence, most of struvite precipitation experiments measured only phosphate removal efficiency. However, several experiments with the addition of phosphate were conducted for evaluation of removal ammonia as well as phosphate.

Manure samples were taken from treated and untreated, and digested and undigested manure effluents. These samples were in dark color and contained suspended solids. Centrifugation was used for solid-liquid separation. Typically, 10 ml of sample solution was centrifuged at 3400 rpm for 10 minutes with a Cole-Parmer centrifuge. After centrifugation, the supernatant of the centrifuged sample was diluted by 50 to 500 times with a Gilson Model 401 dilutor for phosphate analysis. The phosphate concentration in manure effluents was determined by ion chromatography or automated ascorbic acid colorimetric method. Samples for ammonia analysis were not centrifuged. Ammonia nitrogen was determined by the ammonia-selective electrode method. Metal ion analysis, if necessary, was conducted using inductively coupled plasma (ICP).

As for phosphate analysis of manure effluent samples, it was found that the analyzed phosphate concentration was affected by the pre-treatment method. Filtration with a 0.45-μm membrane filter gave a phosphate concentration 10-20% lower than that with the centrifugation pre-treatment. This is likely due to the fact that membrane filtration removed most of the suspended solids to which some phosphate was adsorbed. The phosphate concentrations reported in this study were based on the pre-treatment of centrifugation. It was also found that the ortho-phosphate analyzed by an automated ascorbic acid colorimetric method (Technicon) was higher than that by IC, though there was no difference for analyzing the ortho-phosphate standards. One likely reason was that part of the organic phosphorus in manure was oxidized/converted to ortho-phosphate by the strongly acidic reagent solution used in the Technicon method. From this point of view, IC is more suitable for determination of ortho-phosphate in manure than the automated ascorbic acid colorimetric method.

The operation conditions for struvite precipitation from manure have been explored in small-scale batch experiments. These included pH, Mg/PO₄³⁻ ratio, PO₄⁻/NH₄⁺ ratio, reaction temperature, reaction time, different magnesium salts, and seeding materials. The key results and observations are summarized as follows:
pH 8 is the minimal pH requirement for effective precipitation of struvite from manure effluents, and the operation pH should be controlled between 8.5 and 9.5 for better phosphate removal
There was a considerable amount of phosphate removed (10% for undigested manure and 20% for digested manure) even at the Mg/PO₄³⁻ ratio of zero (no Mg was added). This is most likely due to the fact that a certain amount of Mg and Ca ions already existed in the cattle manure, which resulted in struvite and calcium phosphates precipitation at an elevated pH.
Since the amount of ammonia in manure effluent was largely over the amount of phosphate, theoretically, most of phosphate should be removed at the Mg/PO₄³⁻ molar ratio of one. However, the phosphate removal efficiency obtained from experiments was much below one when the Mg/PO₄³⁻ molar ratio reached one and was only about 40-60% even at the ratio over 5. It is likely that there are some inhibitory effects to retard the struvite precipitation from manure effluents, presumably due to the extremely complicated matrix and the high content of suspended solids in manure effluents. Therefore, a large Mg/PO₄³⁻ ratio is apparently required for struvite precipitation from manure effluents. This would consequently increase chemical cost for nutrient recovery.
The phosphate removal efficiency was only slightly improved when the reaction temperature increased from 5 to 35° C. Therefore, the struvite precipitation from manure is not significantly affected by temperature at this range. The operation temperature for the struvite precipitation reactor can be set to an ambient (room) temperature (20° C.).
30 minutes of reaction time is found to be enough for achievement of proper nutrient removal efficiency. However, it suggests that a residence time of 45-60 minutes for the struvite precipitation reactor design should be used.
The ammonia nitrogen content in the manure effluents was much higher than the phosphate content, so that the ammonia removal through struvite precipitation was increased with an increase of the PO₄³⁻/NH₄⁺ ratio by adding phosphate into the manure effluents. Experimental results showed that less ammonia was removed compared to the removed phosphate, implying that some phosphate in the manure effluent was removed as phosphate compounds other than struvite. Magnesium phosphates and calcium phosphates are most likely two of those compounds.
Several materials were tried as seeding for struvite precipitation from manure, including struvite powders, sand, fly ash, and bentonite powders. Sand appeared the best seeding material in terms of the measured phosphate removal efficiency. The addition of struvite powders did not show any improvement on phosphate removal, likely due to an increased dissolution of struvite at a longer reaction time. However, the addition of struvite as seeding may increase the crystal size of the precipitated struvite.
An interesting observation from the experiments was that struvite precipitation appeared to be more efficient with digested manure than with undigested manure.

### Example 8

### Ammonia Stripping Using CO₂-Enriched Gas

Two types of solutions were used in this set of stripping experiments: ammonium chloride solution (NH₄Cl) and digested cattle manure effluent. An ammonium solution of 2000 mg/L as ammonia nitrogen (NH₃—N) was prepared by dissolving solid NH₄Cl (BDH, Analytical reagent, 99.5% min) in water. The digested cattle manure effluent used in the experiments was produced in a pilot digester, which was a continuous stirred tank reactor. Before ammonia stripping, the digested effluent was centrifuged using a pilot disc centrifuge, and then treated using lime precipitation to remove phosphate. The total solids content in the effluent before entering the stripping tower was approximately 2.5%. It had an ortho-phosphate concentration of <10 mg/L as P and ammonia concentration of approximately 2000 mg/L as NH₃—N. NaOH solution (10 N) was used for increasing pH.

CO₂ gas (BOC, industrial grade, 99%) was used in the stripping experiments as the stripping gas. Different concentrations of CO₂ were obtained by diluting a high concentration CO₂ from a cylinder with compressed air.

Ammonia stripping experiments were conducted in a semi-batch mode, batch for the liquid phase and continuous flow for the gaseous phase. The stripping column made of Plexiglass had an internal diameter (ID) of 4 cm, a height of 100 cm in the packing zone and 35 cm in the extended zone above packing. A liquid feeding tube was centrally installed at a location 25 cm above the packing. The column was packed with 0.5-inch Paul rings in a total packing volume of 1.26 L. The stripping gas was made from air and CO₂ in different ratios through two mass flow controllers. The gas mixer had a volume of 4 L and was packed with 0.5-inch Paul rings. The gas heater was a bronze coil wrapped with two heating tapes (2×624 W). The feed solution was pumped with a Masterflex pump from the feed tank to the top of the column. The feed tank was mechanically stirred. The stripped effluent was collected at the bottom of the column and recycled to the feed tank. The feed tank was heated with an immersible heater (1000 W). The gas heater and the heater in the feed tank were controlled separately by two temperature controllers, through which the temperature in the stripping column could be maintained at any specified value between 20° C. and 70° C. within ±2° C. The solution pH was maintained at a specified value by adding NaOH solution (10 N) with a Masterflex pump into the feed tank. The stripped gas was released after bubbling through two serial ammonia traps, which contained 5% H₂SO₄ solution. The stripping gas and liquid flows in all experiments were set at 20 L/min and 0.15 L/min, respectively.

Individual experiments of ammonia stripping were conducted under different conditions to evaluate the effects of temperature, pH and CO₂ concentration. In each experiment, 5 L of ammonia-containing solution in a concentration of approximately 2000 mg NH₃—N/L was initially loaded in the feed tank, and column temperature, solution pH and CO₂ concentration in the stripping gas were controlled as constant as possible at designated values. The liquid solution after ammonia stripping at the bottom of the stripping column was sampled at an interval of 5 min during the experiment. The ammonia removal efficiency was calculated as percentage by the difference of the ammonia concentration before and after stripping.

Liquid samples were acidified to a pH<6 with 10% H₂SO₄ solution to prevent ammonia from escaping after taken and then diluted 50-100 times for ammonia analysis. The ammonia concentrations in the samples were determined by an ion chromatography (Dionex ICS-1000). The analytical error could be controlled within ±5%. The ammonia concentration in the stripped gas out of the stripping column was not measured.

### Effect of Temperature

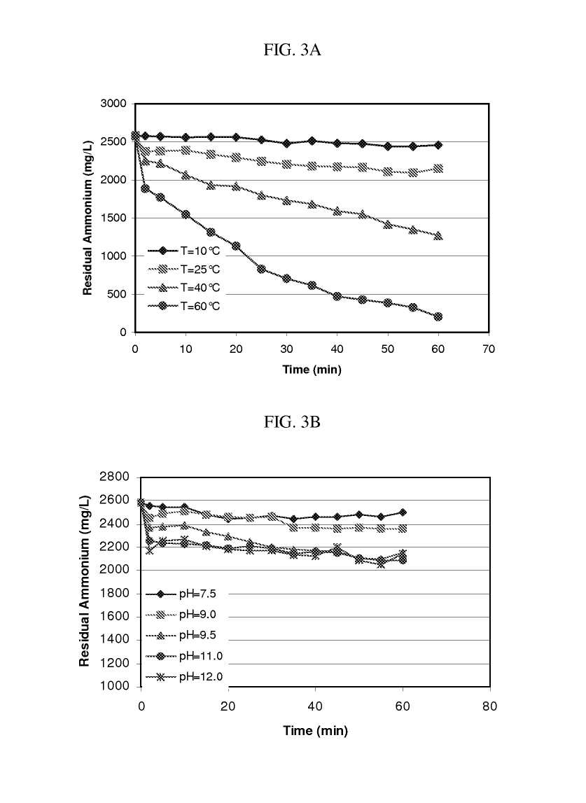

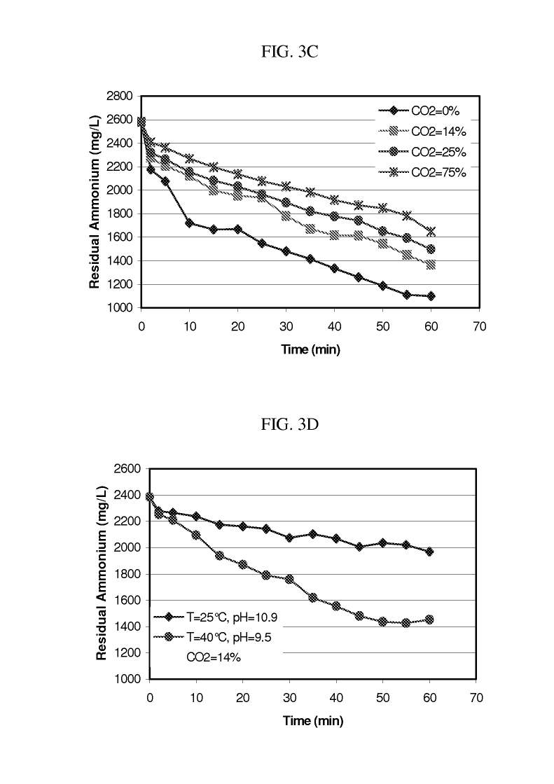

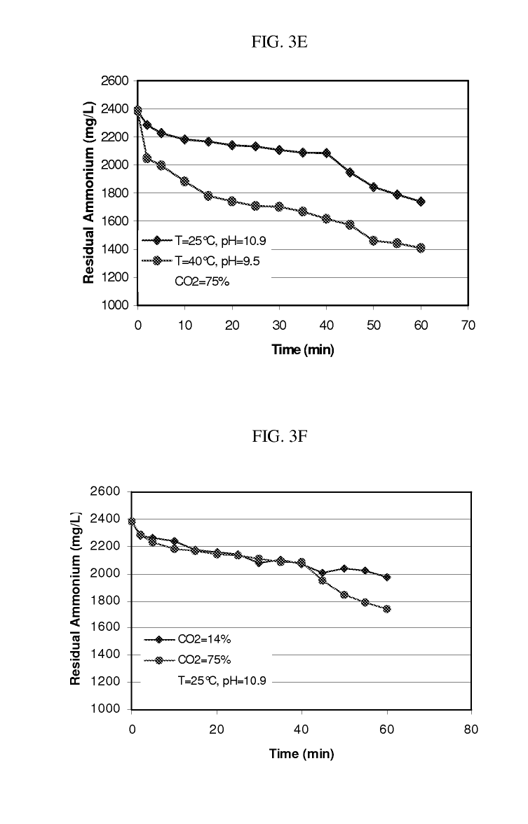

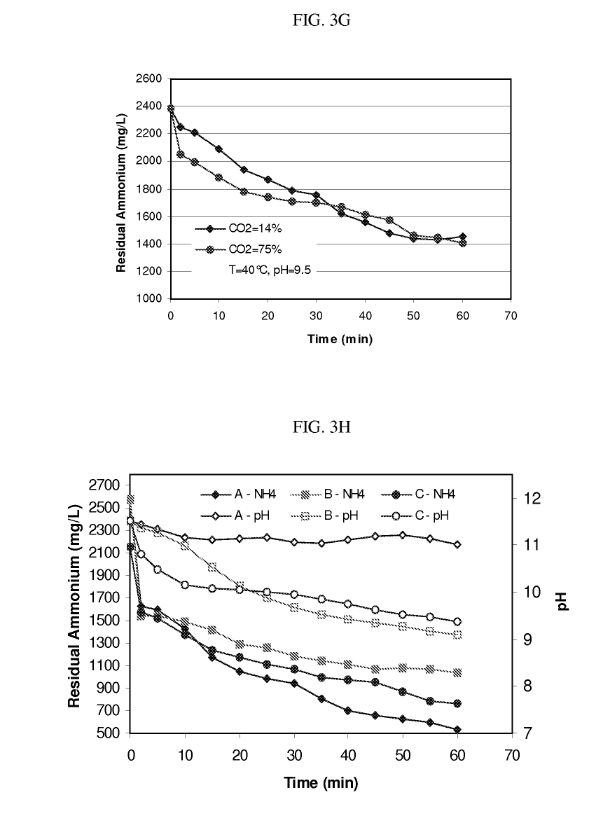

A series of stripping experiments with a 14% CO₂ gas under pH 9.5 were conducted at different temperatures between 10° C. and 60° C. as shown in FIG. 3A. It was found that temperature significantly affected ammonia stripping efficiency. The ammonia stripping efficiency was very low at 10° C. This efficiency considerably increased with increasing temperature. The efficiency was 4%, 15%, 33% and 73% for temperature 10, 25, 40 and 60° C., respectively. A high temperature obviously benefits ammonia stripping. This is attributed to the fact that high temperatures enable a high gas-liquid mass transfer rate by enhancing its driving force (i.e. ammonia solubility in water is lowered). An implication of these results is that the volume of the stripping units can be reduced under a high temperature.

### Effect of pH

A series of stripping experiments with a 14% CO₂ gas and at 25° C. were conducted under different pH between 7.5 and 12.0 as shown in FIG. 3B. It was found that the ammonia stripping efficiency was relatively lower at pH 7.5. It increased with increase of pH. The increase of the stripping efficiency was more pronounced from pH 7.5 to pH 9.5, while less significant from pH 9.5 to pH 12.0.

It was found that the influence of temperature was greater than that of pH. Therefore, increasing stripping temperature can reduce the required pH and consequently reduce alkaline consumption. Meanwhile, the required heat is increased due to an increased stripping temperature. If there is more recovered heat from the biogas system, it is desired to operate stripping at an elevated temperature to reduce alkaline consumption as well as to increase the stripping efficiency.

### Effect of CO₂ Concentration

A series of stripping experiments at 40° C. and pH 9.5 were conducted with different CO₂ concentrations between 0% and 75% as shown in FIG. 3C. It was found that CO₂ concentration affected ammonia stripping. The ammonia stripping efficiency was decreased with increase of the CO₂ concentration. The ammonia stripping efficiency at 30 min was 43%, 31%, 27% and 21% for the CO₂ concentration of 0%, 14%, 25% and 75%, respectively. This result can be explained by the knowledge of the NH₃—CO₂—H₂O system that the CO₂ partial pressure significantly increases with increase of CO₂ in water while the NH₃ partial pressure slightly deceases (Edwards et al., AIChE J. 24(6): 966-976, 1978; Beutler and Renon, Ind. Eng. Chem. Process Des. Dev. 17(3): 220-230, 1978; Pawllkowskl et al., Ind. Eng. Chem. Process Des. Dev. 21: 764-770, 1982; Kawazuishi and Prausnitz, Ind. Eng. Chem. Res. 26: 1482-1485, 1987). With increase of the CO₂ concentration in the stripping gas, the NH₃ partial pressure (concentration) is likely reduced and then less NH₃ can be desorbed from the aqueous solution to the gas phase. Thus, the NH₃ stripping efficiency is decreased. Therefore, a gas containing more than 50% of CO₂ preferably should not be used for ammonia stripping. It may be best to keep CO₂ below 25% in the stripping gas for achieving a reasonably high stripping efficiency.

Ammonia Stripping from Digested Manure Effluent

So far, all of the above experiments were conducted using NH₄⁺ solutions. Two sets of stripping experiments below were conducted using digested manure effluent. One was at 25° C. and pH 10.9, and another at 40° C. and pH 9.5, both with 14% and 75% CO₂ gas, respectively. With 14% CO₂ gas, the stripping efficiency at 40° C. and pH 9.5 was larger than that at 25° C. and pH 10.9 (FIG. 3D). A similar result was obtained when using 75% CO₂ gas (FIG. 3E). These results are generally in agreement with the observation obtained previously that the influence of temperature was greater than that of pH in experiments using chemical solutions.

The effect of CO₂ concentration in stripping gas on the ammonia stripping efficiency was also investigated. The stripping efficiency with 75% CO₂ was very similar to that with 14% CO₂ under 25° C. and pH 10.9 (FIG. 3F). This phenomenon was repeated under the conditions of 40° C. and pH 9.5 (FIG. 3G). These results were apparently contradicted to those obtained previously that when using CO₂ gas for ammonia stripping, the stripping efficiency was decreased with increase of the CO₂ concentration. However, this can be explained by the fact that the formation of carbonate precipitates can reduce free CO₂ in solution. As is well known, considerable amounts of metal ions (such as Ca and Mg) existing in manure effluent can form carbonate precipitates and thus reduce the free CO₂ in solution. As a result, NH₃ partial pressure is less decreased with increase of gaseous CO₂ concentration and hence the NH₃ stripping efficiency would not be significantly affected by increasing the CO₂ concentration in the stripping gas.

### Ammonia Stripping Without Maintaining pH

Three stripping experiments were conducted at 40° C. without maintaining the process pH. In these experiments, the initial pH of the solutions was adjusted to 11.5 with 10 N NaOH and then no alkaline was further added during stripping. The pH change and the ammonia stripping efficiency are shown in FIG. 3H. It was found that pH value decreased in different extents during ammonia stripping. The experiment using air (Run A, 0% CO₂) had much less pH drop than the experiment using 14% CO₂ gas (Run B), because the dissolution of CO₂ decreased pH in the latter run. Consequently, the former experiment achieved a higher efficiency of ammonia stripping than the latter. In another experiment testing ammonia stripping from manure effluent using 14% CO₂ gas (Run C), pH dropped quickly from 11.5 to 10.2 in the first 10 min.

Comparing experiments B and C (both using 14% CO₂), pH decreased less for the experiment using digested manure effluents (Run C). Consequently, ammonia stripping efficiency of the latter was higher than that of the former. This is attributed to the buffering ability of the manure effluent.

In all three experiments, it appeared that the ammonium concentration dramatically decreased in the first 2 min. This is likely due to the fact that the samples at the time zero were taken before pH adjustment while the experiments started after pH was adjusted to 11.5. Since the feeding tank of ammonium solution was not completely covered, a significant amount of ammonia might be released at this high pH (11.5) and high temperature (40° C.) during pH adjustment before start.

### Alkaline Consumption During NH₃ Stripping

Alkaline consumption was measured in several ammonia stripping experiments using synthetic ammonium solution and digested manure effluent as shown in FIG. 3I. Alkaline consumption generally increased with the CO₂ concentration in the stripping gas. A high operation pH obviously consumed more alkaline. These results suggested that ammonia stripping by CO₂ enriched gas should be conducted at a higher temperature to reduce alkaline consumption. This suggestion coincided with the early finding that the ammonia stripping efficiency was higher at a higher temperature.

### pH Adjustment of Digested Manure Effluents Using CO₂

CO₂ gas (BOC, industrial grade, 99%) was supplied from a gas cylinder. The centrifuged digested manure effluents before and after lime treatment as well as tap water were used in pH adjustment experiments. The initial pH of these solutions in different experiments was adjusted with 10 N NaOH. Experiments for pH adjustment by bubbling CO₂ were conducted in a 1.5-L plastic cylindrical vessel. A piece of tubing with two frits was set on the bottom of the vessel for bubbling CO₂ gas. A mechanical stirrer was installed in the vessel for mixing CO₂ with solution. A pH probe was placed in the solution to measure pH values. The input CO₂ flow rate was controlled by an Aalborg mass flow controller (Model GFC 171S).

In each experiment, 1 L of aqueous solution (manure effluent or tap water) was added into the vessel and stirred at room temperature (20±1° C.). CO₂ gas was bubbled into the solution at a rate of 200 mL/min. The pH value was monitored and recorded during CO₂ bubbling.

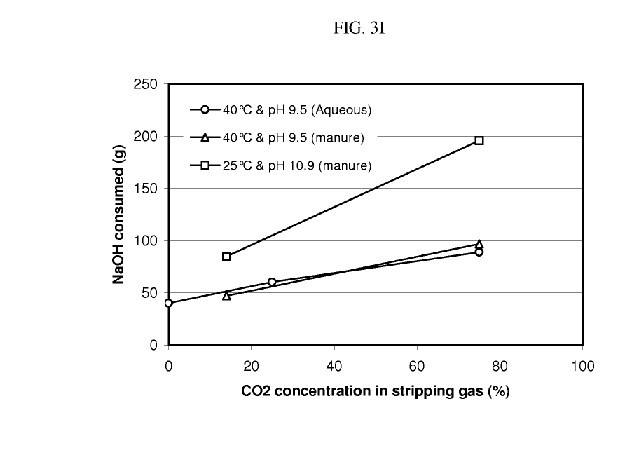

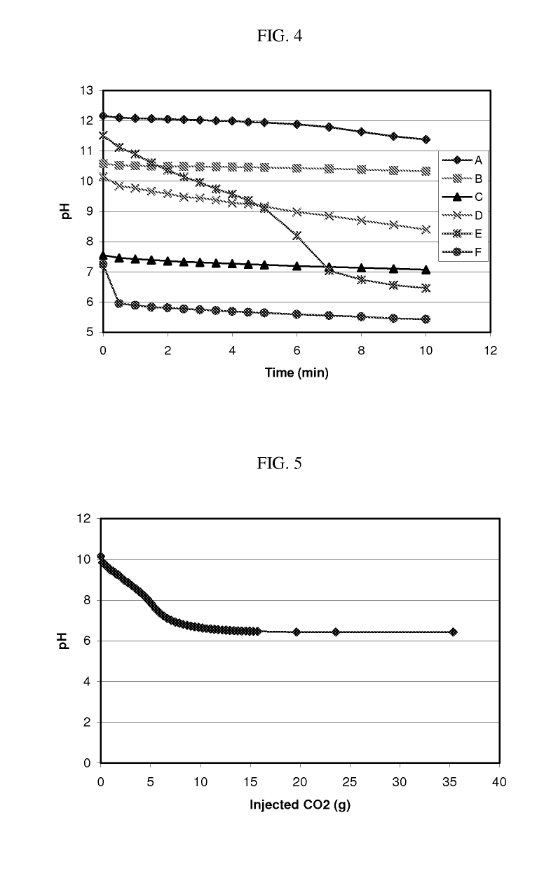

The results of several experiments for measuring pH change during CO₂ bubbling through manure effluents or tap water were obtained and shown in FIG. 4. The pH value in either manure effluent or tap water decreased during CO₂ bubbling, due to the CO₂ dissolution. pH changing curves for manure effluents with different initial pH were almost parallel to each other. The pH value was dropped less for manure effluent than for water, obviously attributed to the buffering capacity of the former. It was observed from the curve slope that the pH decrease rate for the lime-treated manure effluent was larger than that for untreated manure effluent. This is likely because lime-treatment has already overcome part of the buffering capacity. The water pH decreased rapidly when the pH value was approximately above 7, while it changed less when the pH value was close to or below 7.

To determine the required CO₂ for pH adjustment of lime-treated manure effluent from an anaerobic digestion process, an experiment of CO₂ bubbling through lime-treated manure effluent was conducted for up to 90 min. The result of pH change with the injected CO₂ is shown in FIG. 5. It was found that the pH value reached about 6.5 after approximately 11.8 g of CO₂ was injected (30-min of CO₂ bubbling at a rate of 0.2 L/min) and then pH had little change with further CO₂ bubbling. In fact, the linear range of pH reduction with CO₂ injection was about 10.0 to 7.4, and the corresponding CO₂ injection was 0 to 5.9 g/L. From pH 7.4, the pH reduction was insignificant regardless of CO₂ injection.

Although the pH value of the lime-treated manure effluent can be adjusted to 6.5 by CO₂ in above experiment, a pH value of 7.5-8.5 in the treated solution is good for a purpose of discharge.

If CO₂ gas is supplied from an ethanol production which has a CO₂ generation rate of 0.4573 m³ CO₂/L ethanol (Paul, Noyes Data Corporation, New Jersey, U.S.A., p. 102-104, 1980), the production capability of the ethanol plant needs to be at least 1113 L ethanol/day or 406,270 L/year. If CO₂ gas is from the exhaust of biogas combustion which contains about 14% CO₂, the volume of the exhaust needs to be at least 3636 m³/day.

Other ammonia stripping experiments and conditions were described in Zeng et al., (ADSW 2005 Conference Proceedings—Vol. 1, Sessions 8b: Economical Evaluation), the entire contents of which is incorporated herein by reference.

### Example 9

### Ammonia Sorption by Bio-Solids

To test ammonia sorption by bio-solids, ammonia was obtained from an ammonia gas cylinder purchased from Praxair Canada, which contained 8.0% (volume) NH₃ with a balance of air. The cylinder had a total volume of 29.5 L and a pressure of 4000 kPa. Air was obtained from a cylinder (BOC, ZERO 2.0), which had a total volume of 40 L and a pressure of 15000 kPa. The working gas mixture containing approximately 1% NH₃ was prepared from these two gas cylinders.

The solids used in this study included sand, sawdust, centrifuged digested manure (CDM) solids (or the solid portion of the anaerobic digestate), H₂SO₄-added CDM solids, incubated sulfur-containing CDM solids, and granulated CaSO₄-containing CDM solids, etc. These biosolids were used for different experiments described herein.

First, sand, sawdust and the CDM solids were applied for testifying the influence of the moisture content in solids on ammonia sorption. For this purpose, three moisture content levels were adopted for these three solids, respectively. Before experiments, sand and sawdust were thoroughly washed with DI water, and placed on a coarse filter (a piece of cloth) for two hours to allow the remaining water to leach out. These wet-state sand and sawdust were used as their highest moisture content levels for ammonia sorption, respectively. Correspondingly, the 24 hour air-dried sand or sawdust was applied as the mid-moisture content level, and the 24 hour oven-dried sand or sawdust at 105° C., used as their lowest moisture content levels for ammonia sorption. As for the CDM solids, its original state after centrifugation was taken as the highest moisture content level. Then, the CDM solids were air-dried at 20° C. separately for 24 hours and 72 hours so as to get a desired moisture content for ammonia sorption.

The H₂SO₄-added CDM solids were utilized for evaluating the possibility of ammonia sorption enhancement. In doing so, solutions of 0.2 M, 0.4 M, and 2.0 M H₂SO₄ were prepared from concentrated H₂SO₄. For each ammonia sorption run, 20 ml of the H₂SO₄ solution was added to about 150 g of the CDM solids, and mixed thoroughly for ammonia sorption purpose. The solids moisture contents for the three runs were kept at the same levels (˜53%).

Moreover, the granulated CaSO₄-containing CDM solids, and the SO₄²⁻-containing CDM solids, originated from the incubation of sulfur-containing CDM solids, were used to verify the influence of sulfate on ammonia sorption.

The moisture contents of all the above biosolids were measured before experiments.

### Set-up for Ammonia Sorption

The set-up for ammonia sorption on biosolids used in this experiment consisted mainly of three parts: a gas flow controlling system, a sorption column, and a sampling system. In this set-up, two mass flow controllers (MUIS Controls LTD, Canada; MKS Instrument Inc., USA) were used to adjust ammonia gas and air from two separate cylinders. The sorption column made of polypropylene had an internal diameter of 1.8 cm and a length of 46.2 cm between the inlet and the outlet. The column volume for packing the CDM solids was approximately 0.12 L. Another column used for ammonia sorption by granular CDM solids had an internal diameter of 3.7 cm and a length of 43 cm between the inlet and the outlet. The column volume for packing the granular CDM solids was approximately 0.46 L. Tygon tubing was used to connect all gas passages. The gas mixer was a small polypropylene column, had an internal diameter of 3.5 cm and a length of 25.5 cm, and packed with small Pall rings. A gas impinger was used as the gas sampler for absorbing ammonia from the gas mixture. One three-way valve was used for switching gas passages between the sorption column and the by-pass. Another similar valve was used for switching between the gas sampler and the vent.

### Ammonia Sorption Procedure

All experiments were conducted at room temperature (˜20° C.). Before each experiment, a fixed amount of solids was weighed and packed into the sorption column. The flow rate of ammonia gas from the ammonia cylinder was controlled at 0.42 L/min, and air at 1.82 L/min. Both three-way valves were set to make the gas mixture go to vent. When the gas streams were stable over 10 minutes, the three-way valve was switched to sampling through the impinger. Several impingers were used for gas sampling during the experiments. In doing so, 400 ml of 0.01 M H₂SO₄ was placed in each impinger for absorbing ammonia from the gas mixture. At a fixed period of sampling, ammonia from a known volume of gas mixture was absorbed by H₂SO₄ solution in the impinger and analyzed using an ammonia probe.

After a few samples were taken and measured to confirm that the inlet ammonia concentration was maintained constant, the three-way valves and the two-way valve were switched to make gas mixture go through the sorption column for starting ammonia sorption operation. During column sorption of ammonia, the samples were taken from the outlet of the column and measured for ammonia concentration approximately every 10 minutes for the first 2 hour. Then the sampling interval was increased to every 20 minutes per sample for the rest 2 hour. Then the valves were switched back to the by-pass, and two final samples were taken and measured to verify the inlet ammonia concentration.

At the end of the experiment, the packed solids were removed from the column, placed in a polyethylene bottle, and stored in a refrigerator at 4° C. These solids were analyzed for total nitrogen, phosphate and sulfate.

### Evaluation of Total Nitrogen, Phosphate and Sulfate Changes During Air-Drying for Ammonia-Sorbed Solids

To determine the influence of the moisture content on the total nitrogen (TN), phosphate and sulfate, air drying was carried out for comparing the capabilities of holding ammonia, phosphate, and sulfate in CDM solids, H₂SO₄-added CDM solids, and incubated sulfur-containing CDM solids. Ammonia sorption experiments were first conducted for these three solids, and the ammonia sorbed solids were then air-dried at room temperature (20° C.) separately for 0, 2, 4, 8, 12, 16, 20, 24, and 72 hrs. These solids samples were then subjected to wet digestion using concentrated H₂SO₄ for the analysis of total nitrogen and phosphate.

### Analytical Methods

Ammonia concentration in the impinger solution was measured using an ammonia probe (ORION) in conjunction with a Model 450 CORNING pH/ion meter (Laboratory Equipment, UK). Prior to the experiment, the ammonia probe was calibrated using standard NH₄Cl solutions containing 2, 5, 10, 20, and 50 mg N/L, respectively. For ammonia measurement, 25 ml of the solution was poured into an 80-ml beaker with a magnetic stirrer. The ammonia probe was then placed into the solution. The pH of the sample was adjusted to between 11 to 14 by adding 1 ml of 10 N NaOH solution into the beaker. Ammonia concentration of the sample could be read directly from the pH/ion meter.

The content of total nitrogen in the biosolids was determined by a wet digestion method following an ammonium analysis using a Dionex ICS-1000 ion chromatography (IC). The phosphate concentration in the same wet-digestion solution was also determined by IC.

The sulfate content in the biosolids was determined by a CaCl₂ extraction method following a sulfate analysis using a Dionex ICS-1000 IC. Normally a 5 g solids sample was dispensed into a 50-mL Erlenmeyer flask, and then 20 ml of 0.01 M CaCl₂ solution was added into the flask. The flask was shaken for 30 minutes and the extraction mixture was filtrated through Whatman #42 filter paper. The filtrate was collected and analyzed for sulfate by using IC.

### Influence of Moisture Content in Solids on Ammonia Sorption Capacity

Sand, sawdust and the CDM solids were used for justifying the mechanisms of ammonia sorption on the solids. Ammonia sorption experiments were carried out using sand, sawdust, and CDM solids. It was found that the ammonia sorbed in sawdust and CDM solids increased nearly linearly with the moisture content. The two curves were quite close to each other. This result suggests that the moisture content play a similar role in ammonia sorption on sawdust and CDM solids. The moisture content in the sand samples is small due to its lower water-holding capability, and it led to a lower ammonia sorption capacity that is much smaller than those of sawdust and the CDM solids.

The implication of these results is that moisture content in solids plays an important role in ammonia sorption.

However, ammonia sorbed in the solids easily escaped during subsequent air-drying at room temperature. Total nitrogen also changed with air-drying time. At the beginning of drying, total nitrogen concentration in the CDM solids was about 53 g-NH₄⁺/kg dry solids. After 24 h air-drying, total nitrogen decreased to 30.2 g-NH₄⁺/kg dry solids whereas the moisture content in solids decreases from 64% to 10.1%. Compared to the CDM solids, sawdust has a lower ammonium contents after 24 h air-drying (16.2 g-NH₄/kg dry solids), despite the similar moisture contents (9-10%). It can also be seen that a significant amount of NH₃ was retained at a moisture content of about 10% and that ammonia sorbed in the sawdust could be more easily released than that in the CDM solids during moisture content reduction. This suggests that ammonia absorption by water be an important mechanism for ammonia sorption on the CDM solids. However, the experiments did not rule out other sorption mechanisms, such as biosorption by bacterial action.

### Influence of the Granulated CDM Solids on Ammonia Sorption Capacity

Granulated CDM solids used herein had a moisture content of 79.2%. Ammonia sorption experiments were carried out using a bigger column for the granulated CDM solids. Two separate runs were conducted with the different solids load in the column. It was shown that the loaded quantity of the granulated CDM solids in the column affects the ammonia sorption capacity, though the biosolids used in the two runs had the same moisture contents. When the loaded capacity of granulated CDM solids in the column increased from 0.24 to 0.29 kg (wet state), the ammonia sorbed increased from 46.7 to 61.9 g/kg dry solids. This result could be explained by the fact that the high loading of the granulated CDM solids contained more water inside the solids, which caused an increase in ammonia sorption. Furthermore, the high loaded capacity of the granulated CDM solids exhibited better dynamic characteristics of ammonia sorption on this biosolids column, which likely improved the gas-solids contact condition in the column and increased ammonia sorption capacity. Ammonia sorption capacities of both solids were close at a similar moisture content. This again suggested the important effect of water on ammonia sorption.

Trials of Ammonia Sorption with the Lime-Treated CDM Solids

Ammonia sorption was also tested using the lime-treated CDM solids. Compared to the CDM solids, the lime-treated CDM solids showed a slightly lower ammonia sorption capacity. This is likely attributed to the fact that the lime-treated manure had a higher pH than the CDM solids.

### Ammonia Sorption on H₂SO₄-Added CDM Solids

To enhance ammonia sorption on the CDM solids, a certain amount of H₂SO₄ was added into the solids (˜53% moisture content). Ammonia sorption capacities obtained from these runs were compared with another run by using CDM solids without any addition of H₂SO₄ (moisture content 62.7%).

Ammonia sorption capacity increased with the H₂SO₄ content in the CDM solids. When the H₂SO₄ content reached the level of 0.033 kg/kg dry-solids, the ammonia sorption capacity was nearly doubled compared to that for the H₂SO₄-free solids. The total nitrogen content in the ammonia-sorbed solids decreased during air-drying of the solids. However, the higher the H₂SO₄ content in the solids, the more the total nitrogen finally remained in the solids. This suggested that H₂SO₄ was helpful not only for ammonia sorption from the air-NH₃ gas mixture, but also for retaining the ammonia sorbed in the biosolids. In principle, the ammonia sorbed in the solids could react with H₂SO₄ to form ammonium sulfate.

Ammonia Sorption with the Incubated Sulfur-Containing CDM Solids

To enhance ammonia sorption in the CDM solids, it was proposed to add different amounts of sulfur to the CDM solids and to convert the sulfur into sulfate by means of bioreaction. In doing so, incubation was carried out in the incubator at 30° C. for 15 days. Three different initial sulfur contents, 0%, 2% and 4% on a dry solids base, were used. The incubation experiments were conducted in triplicate. During the incubation, a certain amount of water was added into the incubated solids daily so as to keep the same moisture content. At Day 0, 3, 7, 10 and 15, the solids samples were taken from each bottle for analyzing the moisture contents and the concentrations of sulfate and phosphate. The total phosphate in the biosolids was analyzed by the digestion method.

Concentration changes of sulfate and phosphate in the incubated sulfur-containing CDM solids were obtained. Both sulfate and phosphate concentrations increase with incubation time. Of all the three biosolids, the solids with the highest sulfur content produced the highest concentration of sulfate and phosphate during the incubation. After fifteen days of incubation, the triplicate samples of each type of the biosolids were mixed together for ammonia sorption experiments. The ammonia sorption curves for these three runs (SDM0-2, SDM1-2 and SDM2-2) showed that the ammonia sorption capacity was 1.28 g, 1.14 g, and 1.11 g NH₃ for SDM0-2, SDM1-2 and SDM2-2, respectively. Converting to the dry base of the biosolids, the corresponding ammonia sorption capacities were 0.070, 0.052 and 0.046 kg NH₃/kg dry solids for these three samples, respectively.

The data suggested that there was no significant difference in ammonia sorption capacities for biosolids SDM0-2, SDM1-2 and SDM2-2, even though the sulfate concentrations in SDM0-2, SDM1-2 and SDM2-2 are quite different (about 0, 0.011 and 0.014 g-SO₄/g-solids, respectively) after the incubation. It is interesting that SDM0-2 showed a slightly bigger capability for ammonia sorption, though it has the lowest sulfate concentration of the three biosolids. This could be attributed to the fact that SDM0-2 solids had a higher moisture content than that of SDM1-2 or SDM2-2. This result also implied that the moisture content in biosolids played an important role on ammonia sorption.

Moreover, total nitrogen in SDM0-2, SDM1-2 and SDM2-2 was determined to verify the effect of sulfate produced in the incubation on the stabilization of ammonia in the solids. The changes of total nitrogen in the biosolids (on a base of dry solids) with drying time showed that the content of total nitrogen in the biosolids decreased with air-drying, i.e., with the decrease of moisture content of the solids. This was likely attributed to the ammonia release during moisture loss. However, the significant decrease of total nitrogen in the biosolids took place during the first 24 hours of air-drying. This was because the moisture contents of SDM0-2, SDM1-2 and SDM2-2, after one day's drying, decreased to 11.18%, 11.34% and 12.33%, respectively. During the following two days of air-drying, the moisture contents were kept almost at the same levels. This suggested that nitrogen contents would not decrease any further. It should be noted that the nitrogen contents in SDM0-2, SDM1-2 and SDM2-2 were nearly the same after one day's air-drying, although their initial nitrogen contents were different. These results suggested that the sulfate concentration may not be as important as water for ammonia sorption and ammonia stabilization.

### Trials of Ammonia Sorption on CaSO₄-Containing Granular CDM Solids

In order to verify the effect of biomass containing CaSO₄ on ammonia sorption, different granulated CDM solids were prepared with different moisture or CaSO₄ contents. Results showed that IMUS-1, IMUS-2, IMUS-3, and IMUS-5 had similar ammonia sorption curves since their moisture contents were quite close to one another, indicating that these granulated solids had similar ammonia sorption capacities (0.47±0.02 g NH₃/kg solids). Compared to IMUS-1, IMUS-2, or IMUS-5, IMUS-3 contains about 6% CaSO₄ in a dry base. However, the presence of CaSO₄ did not appear to increase ammonia sorption capacity. IMUS-4 apparently had a high potential for ammonia sorption. Part of the reason may be that IMUS-4 had the highest moisture content among the five granulated biomass solids.

### Changes of Total Nitrogen, Phosphate and Sulfate in the Ammonia Sorbed Solids During Air-Drying

Moisture contents in these solids with air-drying were obtained. Moisture contents in these solids almost linearly decreased during air-drying of the solids. However, loss of nitrogen in the solids with air-drying did not occur at the same rate. Nearly a half of the total nitrogen in the solids was lost in the first 20 hours.

Among these three solids, H₂SO₄-added CDM solids had comparably the greatest potential for holding the sorbed ammonia. This might be attributed to the chemical reaction between the sulfuric acid and ammonia in the solids. Although this reaction might increase the holding ability for ammonia to some extent, approximately ⅔ of the total nitrogen finally escaped from the solids after 72 hours air-drying.

The phosphate and sulfate concentrations in these three solids did not have much change during air-drying. This suggested that phosphate and sulfate concentrations in the solids were little influenced by moisture contents. Furthermore, sulfate concentrations in the H₂SO₄-added CDM solids and the incubated sulfur-containing CDM solids were much higher than that in the CDM solids. However, phosphate concentration in the incubated sulfur-containing CDM solids was higher than those in the CDM solids and the H₂SO₄-added CDM solids, even though these sulfate concentrations were almost kept at the same level. This suggested that incubation of the sulfur-containing CDM solids increased not only the concentration of sulfate, but also the concentration of phosphate.

1. A solid-liquid separation method for a bio-waste mixture, comprising:
(1) adding a high molecular weight cationic polyelectrolyte to the bio-waste mixture; and,
(2) separating a solid portion from a liquid portion of the bio-waste mixture through mechanical/physical means.

2. The method of claim 1, wherein the bio-waste mixture is an anaerobic digestate resulting from anaerobic digestion of an organic waste.

3. The method of claim 2, wherein the organic waste comprises one or more of: livestock manure, animal carcasses and offal, plant material, wastewater, sewage, food processing waste, human-derived waste, discarded food, or a mixture thereof.

4. The method of any one of claims 1-3, wherein the bio-waste mixture has a solid content of about 2-15%, about 3-10%, or about 5-8%.

5. The method of any one of claims 1-4, wherein the high molecular weight cationic polyelectrolyte is a CIBA® ZETAG®-type cationic polyelectrolyte or similar synthetic or natural chemical compounds.

6. The method of any one of claims 1-5, wherein the CIBA® ZETAG®-type cationic polyelectrolyte is one or more of: CIBA® ZETAG® 7623/8110, 7645, 7587, and 5250, MAGNAFLOC® 338, 351, 1011, preferably CIBA® ZETAG® 7623/8110 or 7645, or equivalent thereof.

7. The method of any one of claims 1-6, wherein the cationic polyelectrolyte is added to the bio-waste mixture at a final concentration of about 100-1000 mg/L, about 150-400 mg/L, or about 200-300 mg/L, or about 250 mg/L.

8. The method of any one of claims 1-7, wherein, prior to adding the cationic polyelectrolyte to the bio-waste mixture, the bio-waste mixture is mechanically mixed.

9. The method of any one of claims 1-8, wherein the mechanical/physical means includes centrifugation or a sludge dewatering apparatus (e.g., screw press or separator).

10. The method of any one of claims 1-9, further comprising:
(3) adding to the liquid portion a phosphate precipitation agent, and,
(4) settling the resulting phosphate precipitation to produce a second liquid portion.

11. The method of claim 10, wherein the phosphate precipitation agent is lime, woodash, or a Mg salt.

12. The method of any one of claims 1-11, further comprising capturing ammonium from the second liquid portion and purifying the second liquid portion.

13. The method of claim 12, wherein the second liquid portion is purified through one or more steps of microfiltration, ultrafiltration, reverse osmosis, and/or ion exchange.

14. The method of claim 12, wherein the purifying step is carried out prior to the ammonium capturing step.
